(19) United States
(12) Patent Application Publication
(10) Pub. No.: US 2013/0159217 A1
(43) Pub. Date: Jun. 20, 2013

(54) ENVIRONMENTALLY-RESPONSIVE BEHAVIORAL FINGERPRINTING

(71) Applicant: Elwha LLC, a limited liability corporation of the, Bellevue, WA (US)

(72) Inventors: Marc E. Davis, San Francisco, CA (US); Matthew G. Dyor, Bellevue, WA (US); Daniel A. Gerrity, Seattle, WA (US); Xeudong Huang, Bellevue, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Nathan P. Myhrvold, Bellevue, WA (US); Clarence T. Tegreene, Mercer Island, WA (US)

(73) Assignee: Elwha LLC, a limited liability corporation of the State of Delaware, Bellevue, WA (US)

(21) Appl. No.: 13/686,739

(22) Filed: Nov. 27, 2012

Related U.S. Application Data
(63) Continuation-in-part of application No. 13/678,380, filed on Nov. 15, 2012.
Application No. 13/678,380 is a continuation-in-part of application No. 13/673,506, filed on Nov. 9, 2012.
Application No. 13/673,506 is a continuation-in-part of application No. 13/665,841, filed on Oct. 31, 2012.
Application No. 13/665,841 is a continuation-in-part of application No. 13/665,830, filed on Oct. 31, 2012.
Application No. 13/665,830 is a continuation-in-part of application No. 13/631,667, filed on Sep. 28, 2012.
Application No. 13/631,667 is a continuation-in-part of application No. 13/602,061, filed on Aug. 31, 2012.
Application No. 13/602,061 is a continuation-in-part of application No. 13/563,599, filed on Jul. 31, 2012.
Application No. 13/563,599 is a continuation-in-part of application No. 13/552,502, filed on Jul. 18, 2012.
Application No. 13/552,502 is a continuation-in-part of application No. 13/538,385, filed on Jun. 29, 2012.
Application No. 13/538,385 is a continuation-in-part of application No. 13/475,564, filed on May 18, 2012.
Application No. 13/475,564 is a continuation-in-part of application No. 13/373,682, filed on Nov. 23, 2011.
Application No. 13/373,682 is a continuation-in-part of application No. 13/373,677, filed on Nov. 23, 2011.
Application No. 13/373,677 is a continuation-in-part of application No. 13/373,680, filed on Nov. 23, 2011.
Application No. 13/373,680 is a continuation-in-part of application No. 13/373,684, filed on Nov. 23, 2011.
Application No. 13/373,684 is a continuation-in-part of application No. 13/373,685, filed on Nov. 23, 2011.
(60) Provisional application No. 61/572,309, filed on Oct. 13, 2011.
(60) Provisional application No. 61/632,836, filed on Sep. 24, 2011.

(51) Int. Cl. H04L 29/06; G06Q 40/00

(52) U.S. Cl. CPC H04L 63/10; G06Q 40/00
USPC 705/400; 726/3

(57) ABSTRACT

Disclosed herein are example embodiments for environmentally-responsive behavioral fingerprinting. For certain example embodiments, one or more devices may: (i) obtain at least one environmental parameter relating to an event to potentially occur in conjunction with at least one user device; or (ii) perform at least one analysis for the event based at least partially on the at least one environmental parameter and at least partially on at least one utilization indicator of a behavioral fingerprint that is associated with the at least one user device. However, claimed subject matter is not limited to any particular described embodiments, implementations, examples, or so forth.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

Priority Applications:
(1) For purposes of the USPTO extra-statutory requirements, the present application claims benefit of priority of U.S. Provisional Patent Application No. 61/632,836, entitled “Behavioral Fingerprint Based Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 24 Sep. 2011 (with Atty. Docket No. SE1-0540-US), which was filed within the twelve months preceding the filing date of the present application or is an application of which a currently co-pending application is entitled to the benefit of the filing date.
(2) For purposes of the USPTO extra-statutory requirements, the present application claims benefit of priority of U.S. Provisional Patent Application No. 61/572,309, entitled “Network Acquired Behavioral Fingerprint for Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 3.3 Oct. 2011 (with Atty. Docket No. SE1-0541-US), which was filed within the twelve months preceding the filing date of the present application or is an application of which a currently co-pending application is entitled to the benefit of the filing date.
(3) For purposes of the USPTO extra-statutory requirements, the present application constitutes a continuation-in-part of U.S. patent application Ser. No. 13/373,685, entitled “Behavioral Fingerprint Device Identification”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0542-US), which is currently co-pending or is an application of which a currently co-pending application is entitled to the benefit of the filing date.
(4) For purposes of the USPTO extra-statutory requirements, the present application constitutes a continuation-in-part of U.S. patent application Ser. No. 13/373,684, entitled “Behavioral Fingerprint Controlled Automatic Task Determination”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0543-US), which is currently co-pending or is an application of which a currently co-pending application is entitled to the benefit of the filing date.
(5) For purposes of the USPTO extra-statutory requirements, the present application constitutes a continuation-in-part of U.S. patent application Ser. No. 13/373,680, entitled “Behavioral Fingerprint Controlled Theft Detection and Recovery”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0544-US), which is currently co-pending or is an application of which a currently co-pending application is entitled to the benefit of the filing date.
(6) For purposes of the USPTO extra-statutory requirements, the present application constitutes a continuation-in-part of U.S. patent application Ser. No. 13/373,677, entitled “Trust Verification Schema Based Transaction Authorization”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0545-US), which is currently co-pending or is an application of which a currently co-pending application is entitled to the benefit of the filing date.
(7) For purposes of the USPTO extra-statutory requirements, the present application constitutes a continuation-in-part of U.S. patent application Ser. No. 13/373,682, entitled “Social Network Based Trust Verification Schema”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011 (with Atty. Docket No. SE1-0546-US), which is currently co-pending or is an application of which a currently co-pending application is entitled to the benefit of the filing date.
(8) For purposes of the USPTO extra-statutory requirements, the present application constitutes a continuation-in-part of U.S. patent application Ser. No. 13/475,564, entitled “Behavioral Fingerprint Based Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 18 May 2012 (with Atty. Docket No. SE1-0547-US), which is currently co-pending or is an application of which a currently co-pending application is entitled to the benefit of the filing date.
(9) For purposes of the USPTO extra-statutory requirements, the present application constitutes a continuation-in-part of U.S. patent application Ser. No. 13/538,385, entitled “Network Acquired Behavioral Fingerprint for Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 29 Jun. 2012 (with Atty. Docket No. SE1-0548-US), which is currently co-pending or is an application of which a currently co-pending application is entitled to the benefit of the filing date.
(10) For purposes of the USPTO extra-statutory requirements, the present application constitutes a continuation-in-part of U.S. patent application Ser. No. 13/552,502, entitled “Relationship Based Trust Verification Schema”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 18 Jul. 2012 (with Atty. Docket No. SE1-0549-US), which is currently co-pending or is an application of which a currently co-pending application is entitled to the benefit of the filing date.
(11) For purposes of the USPTO extra-statutory requirements, the present application constitutes a continuation-in-part of U.S. patent application Ser. No. 13/563,599, entitled “Multi-Device Behavioral Fingerprinting”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Jul. 2012 (with Atty. Docket No. SE1-0636-US), which is currently co-pending or is an application of which a currently co-pending application is entitled to the benefit of the filing date.
(12) For purposes of the USPTO extra-statutory requirements, the present application constitutes a continuation-in-part of U.S. patent application Ser. No. 13/602,061, entitled “Behavioral Fingerprinting Via Social Networking Interaction”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Aug. 2012 (with Atty. Docket No. SE1-0637-US), which is currently co-pending or is an application of which a currently co-pending application is entitled to the benefit of the filing date.
(13) For purposes of the USPTO extra-statutory requirements, the present application constitutes a continuation-in-part of U.S. patent application Ser. No. 13/631,667, entitled “Behavioral Fingerprinting Via Derived Personal Relation”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 28 Sep. 2012 (with Atty. Docket No. SE1-0638-US), which is currently co-pending or is an application of which a currently co-pending application is entitled to the benefit of the filing date.
(14) For purposes of the USPTO extra-statutory requirements, the present application constitutes a continuation-in-part of U.S. patent application Ser. No. 13/665,830, entitled “Behavioral Fingerprinting Via Inferred Personal Relation”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Oct. 2012 (with Atty. Docket No. SE1-0639-US), which is currently co-pending or is an application of which a currently co-pending application is entitled to the benefit of the filing date.
(15) For purposes of the USPTO extra-statutory requirements, the present application constitutes a continuation-in-part of U.S. patent application Ser. No. 13/665,841, entitled “Behavioral Fingerprinting Via Corroborative User Device”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Oct. 2012 (with Atty. Docket No. SE1-0640-US), which is currently co-pending or is an application of which a currently co-pending application is entitled to the benefit of the filing date.
(16) For purposes of the USPTO extra-statutory requirements, the present application constitutes a continuation-in-part of U.S. patent application Ser. No. 13/673,506, entitled “Behavioral Fingerprinting Via Social Network Verification”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 9 Nov. 2012 (with Atty. Docket No. SE1-0641-US), which is currently co-pending or is an application of which a currently co-pending application is entitled to the benefit of the filing date.
(17) For purposes of the USPTO extra-statutory requirements, the present application constitutes a continuation-in-part of U.S. patent application Ser. No. 13/678,380, entitled “Behavioral Fingerprinting with Adaptive Development”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 15 Nov. 2012 (with Atty. Docket No. SE1-0642-US), which is currently co-pending or is an application of which a currently co-pending application is entitled to the benefit of the filing date.

Related Applications:

None

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BRIEF DESCRIPTION OF THE FIGURES

FIG. 1 is a schematic diagram of a user device, a server device, and at least one behavioral fingerprint, any of which may be involved individually or jointly in example authentication scenarios in accordance with certain example embodiments.

FIG. 2A is a schematic diagram of multiple user devices, multiple server devices, and at least one behavioral fingerprint, any of which may be involved individually or jointly in example authentication scenarios in accordance with certain example embodiments.

FIG. 2B is a schematic diagram of multiple user devices, multiple server devices, and multiple example locations for at least a portion of at least one behavioral fingerprint in accordance with certain example embodiments.

FIG. 3 is a schematic diagram illustrating an example behavioral fingerprint including one or more example indicators of one or more behavior-related acts in accordance with certain example embodiments.

FIG. 4 is a schematic diagram of an example user device including one or more example components in accordance with certain example embodiments.

FIG. 5 is a schematic diagram of an example server device including one or more example components in accordance with certain example embodiments.

FIGS. 6A and 6B are schematic diagrams of an example user device and an example server device, respectively, that have one or more functional modules in accordance with certain example embodiments.

FIG. 7A is a schematic diagram that includes at least one example device that is capable of handling scenarios for environmentally-responsive behavioral fingerprinting in accordance with certain example embodiments.

FIGS. 7B-7D are schematic diagrams that include at least one example device and that depict example scenarios for implementing environmentally-responsive behavioral fingerprinting in accordance with certain example embodiments.

FIG. 8A is a flow diagram illustrating an example method for at least one device with regard to environmentally-responsive behavioral fingerprinting in accordance with certain example embodiments.

FIGS. 8B-8D depict example additions or alternatives for a flow diagram of FIG. 8A in accordance with certain example embodiments.

FIGS. 9A-9D depict example additions or alternatives for a flow diagram of FIG. 8A in accordance with certain example embodiments.

FIGS. 10A-10B depict example additions or alternatives for a flow diagram of FIG. 8A in accordance with certain example embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

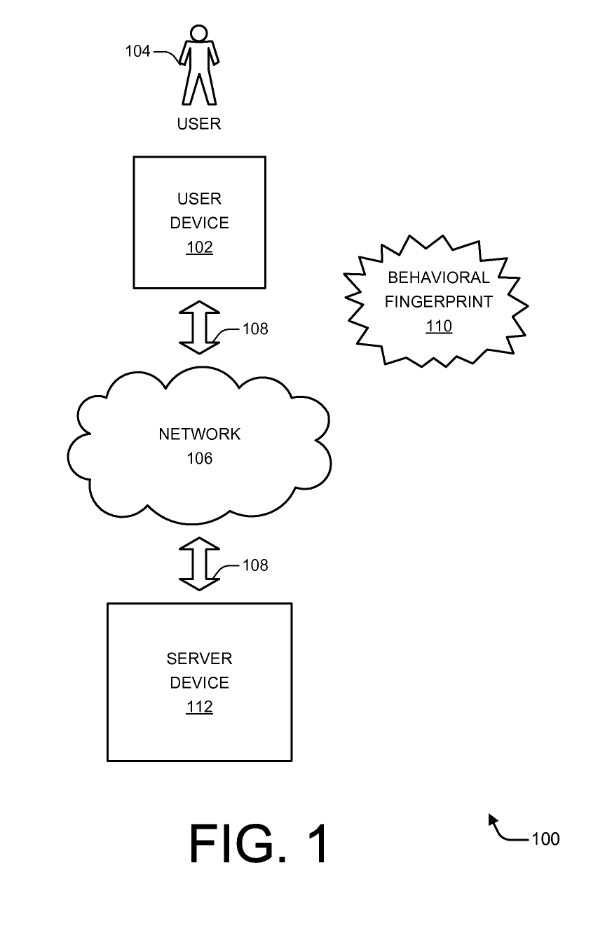

FIG. 1 is a schematic diagram 100 of a user device, a server device, and at least one behavioral fingerprint, any of which may be involved individually or jointly in example authentication scenarios in accordance with certain example embodiments. As shown in FIG. 1, by way of example but not limitation, schematic diagram 100 may include at least one user device 102, at least one user 104, at least one network 106, at least one channel 108, at least one behavioral fingerprint 110, or at least one server device 112. More specifically, at least one channel 108 may extend from or lead to a device 102 or 112 to facilitate communication therewith.

For certain example embodiments, a user 104 may correspond to or be utilizing at least one user device 102. A user 104 may utilize a user device 102 in accordance with a usage that may be at least partially represented by, modeled by, incorporated into, stored at, tracked by, summarized in, or a combination thereof, etc. at least one behavioral fingerprint 110. A user device 102 may include or comprise, by way of example but not limitation, a mobile phone, a smart phone, a mobile terminal, a laptop or notebook computer, a personal digital assistant (PDA), a netbook, an entertainment appliance (e.g., a television, a gaming console, a set-top box, a music player, or a combination thereof, etc.), a portable gaming device, a user equipment, a tablet or slate computer, a desktop computer, a personal navigation device (PND), a vehicle with user-accessible computational capabilities, videoconferencing equipment, some combination thereof, or so forth. A user 104 may include or comprise, by way of example only, at least one person, a couple, siblings, a family, a partnership, an organizational group, a company, a robotic user (e.g., a computational entity), an electronic agent, a portion thereof, some combination thereof, or so forth. However, claimed subject matter is not limited to any particular described embodiments, implementations, examples, etc.

For certain example embodiments, a network 106 may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof, or so forth. A node may include, by way of example but not limitation, a server; a router; an end user device, such as a mobile phone, a tablet computer, a desktop computer, an entertainment appliance, a vehicle, or a combination thereof, etc.; a switch; a base station; a gateway; some combination thereof; or so forth. However, claimed subject matter is not limited to any particular described embodiments, implementations, examples, etc.

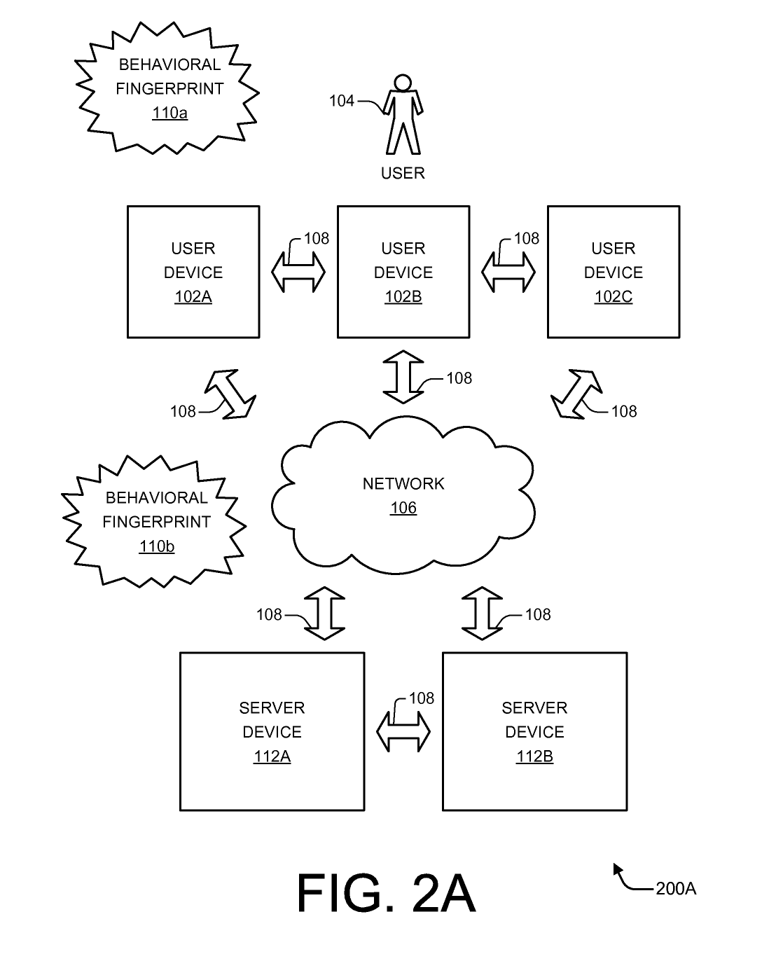

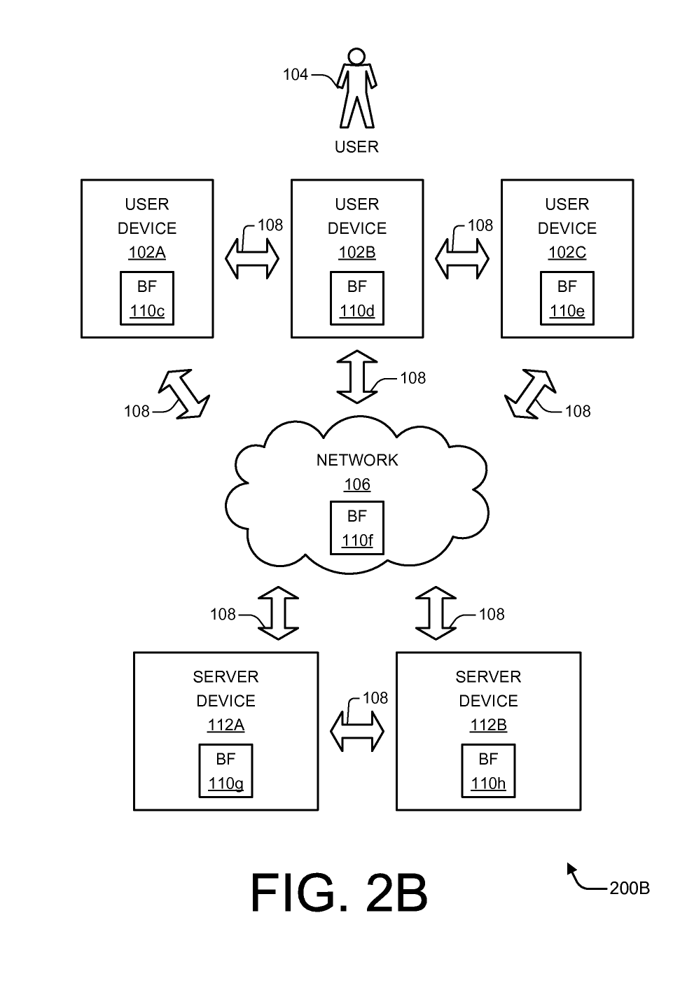

For certain example embodiments, a channel 108 may include, by way of example but not limitation, one or more of: at least one wired link, at least one wireless link, at least part of public network, at least part of a private network, at least part of a packet-switched network, at least part of a circuit-switched network, at least part of an infrastructure network, at least part of an ad hoc network, at least part of a PSTN, at least part of a cable network, at least part of a cellular network connection, at least part of an Internet connection, at least part of a Wi-Fi connection, at least part of a WiMax connection, at least part of an internet backbone, at least part of a satellite network, at least part of a fiber optic network, multiple instances of any of the above, one or more network nodes, some combination of the above, or so forth. A channel 108 may include one or more nodes (e.g., a telecommunication node, an access point, a base station, an internet server, a gateway, an internet or telecommunications switch, or a combination thereof, etc.) through which signals are propagated. A communication may include, by way of example but not limitation, a transmission of data, a reception of data, an exchange of data, a flow of data (e.g., between or among two or more intermediate nodes or endpoints), some combination thereof, or so forth. A user device 102 may communicate with a server device 112, or vice versa, via one or more signals (not explicitly shown) using one or more channels 108. A couple of examples of channels 108 are illustrated in schematic diagram 100 (as well as in additional figures, such as schematic diagram 200A of FIG. 2A). Signals may propagate via one or more channels 108. Signals, by way of example but not limitation, may include, electrical signals, magnetic signals, electromagnetic signals, photonic signals, wireless signals, wired signals, multiples ones thereof, some combination thereof, or so forth. However, claimed subject matter is not limited to any particular described embodiments, implementations, examples, etc.

For certain example embodiments, a server device 112 may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, or so forth. However, claimed subject matter is not limited to any particular described embodiments, implementations, examples, etc.

For certain example embodiments, at least one behavioral fingerprint 110 may include, by way of example but not limitation, one or more indicators representing one or more behaviors of at least one user with respect to at least one user device. Examples of one or more indicators representing one or more behaviors of at least one user with respect to at least one user device may include, but are not limited to, one or more indicators representing one or more habits of at least one user with respect to at least one user device, one or more indicators representing usage of at least one user device by at least one user, one or more indicators representing one or more actions of at least one user with respect to at least one user device, some combination thereof, or so forth. Additionally or alternatively, at least one behavioral fingerprint 110 may include, by way of example but not limitation, one or more indicators representing one or more predicted acts (e.g., behaviors, such as habits, usages, actions, or a combination thereof, etc.) of at least one user with respect to at least one device. Additionally or alternatively, at least one behavioral fingerprint 110 may include, by way of example but not limitation, at least one status of a user that is utilizing or that corresponds to a user device. For certain example implementations, a user whose behavior is being monitored to at least partially establish at least a portion of at least one behavioral fingerprint 110 may comprise an authorized user, which is described herein below. However, claimed subject matter is not limited to any particular described embodiments, implementations, examples, etc.

For certain example embodiments, a user may be utilizing a user device, by way of example but not limitation, if the user is accessing the user device, if the user is interacting with the user device, if the user is carrying the user device, if the user is providing input to the user device, if the user is receiving output from the user device, if the user is directing operation of the user device, some combination thereof, or so forth. A user may correspond to a user device, by way of example but not limitation, if the user is an authorized user of the user device. However, claimed subject matter is not limited to any particular described embodiments, implementations, examples, etc.

For certain example embodiments, a user 104 of a user device 102 may comprise an authorized user of the user device 102: if the user 104 comprises, by way of example but not limitation, a true owner, a manager, an information technology (IT) specialist, a controller, a purchaser, a lessee, an approved borrower, a primary user, or a combination thereof, etc. of the user device 102; if the user 104 is or has been authorized by a true owner, a manager, an IT specialist, a controller, a purchaser, a lessee, an approved borrower, a primary user, or a combination thereof, etc. of the user device 102; some combination thereof; or so forth. In certain example implementations, a determination that a user 104 comprises (e.g., is, is becoming, is being designated, or a combination thereof, etc.) an authorized user of a user device 102: may be effectuated if or when a user first registers a profile, an account, or a combination thereof, etc. on a device (e.g., after a purchase or a ‘hard’ reset); may be effectuated if or when one or more ‘sign-ins’ (e.g., entry of a password, code, PIN, pattern, biometric input, or a combination thereof, etc.) are performed by a user; may be effectuated if or when one or more user ID/secret information combinations (e.g., entry of an account name, email address, individualized identification, or a combination thereof, etc. along with a corresponding password, code, PIN, pattern, biometric input, or a combination thereof, etc.) are entered by a user; may be effectuated if or when a given user is identified as, designated as, or otherwise indicated to comprise an authorized user by one who is already an authorized user; some combination of such authorized user determinations; or so forth. An authorized user may add a new authorized user, by way of example only: by providing a name or other identification of another user or his or her biometric information (e.g., a facial photo, a voice sample, a fingerprint image, a retinal scan, or a combination thereof, etc.); by providing a name or other identification of a user or temporary or permanent secret information, such as a password, a code, a PIN, a pattern, biometric input, or a combination thereof, etc. (e.g., that a newly authorized user may be capable of changing or confirming); some combination thereof; or so forth. An authorized user, such as a true owner or IT specialist, may be empowered to remove someone from a list of authorized user(s). In certain example embodiments, different authorized users may have different levels of authorization (e.g., different levels of access, capabilities, rights, privileges, or a combination thereof, etc.) with respect to a given user device 102. For certain example implementations, but by way of example only, one authorized user may comprise an administrator with full access rights or privileges, yet another authorized user may comprise a regular, non-administrative, or junior user with fewer access rights or privileges. Additionally or alternatively, one authorized user may have full access rights to applications and content stored on a device or associated with a particular account/profile, yet another authorized user may have restricted access rights to applications or content stored on a device such that access is prevented, for instance, to particular device settings or adult content. Other approaches to providing different levels of authorization may also or instead be implemented. By way of example only, an authorized user who is a true owner may add a new authorized user that is permitted to utilize existing applications and content but is prohibited from adding new applications or making particular purchases (e.g., individual purchases above a predetermined dollar amount or multiple purchases beyond a total dollar amount).

FIG. 2A is a schematic diagram 200A of multiple user devices, multiple server devices, and at least one behavioral fingerprint, any of which may be involved individually or jointly in example authentication scenarios in accordance with certain example embodiments. As shown in FIG. 2A, by way of example but not limitation, schematic diagram 200A may include at least one user device 102, at least one user 104, at least one network 106, at least one channel 108, at least one behavioral fingerprint 110, or at least one server device 112. More specifically, schematic diagram 200A may include, by way of example only, three user devices 102 (e.g., a user device 102A, a user device 102B, or a user device 102C, etc.), two server devices 112 (e.g., a server device 112A, or a server device 112B, etc.), or two behavioral fingerprints 110 (e.g., a behavioral fingerprint 110a, or a behavioral fingerprint 110b, etc.).

For certain example embodiments, a user 104 may correspond to or be utilizing multiple user devices 102, such as at least two of user device 102A, user device 102B, or user device 102C, at least partially simultaneously or from time to time. By way of example only, a user 104 may own at least two of: a mobile phone, a tablet computer, a vehicle with an intelligent computing apparatus, a laptop computer, or a desktop computer. For certain example implementations, at least part of a combined behavioral fingerprint 110 (e.g., a behavioral fingerprint 110a/110b) may be associated with a user 104 and each corresponding user device 102. Additionally or alternatively, an individualized behavioral fingerprint 110 (e.g., a behavioral fingerprint 110a or a behavioral fingerprint 110b) may be associated with a user 104 and each corresponding individual or respective user device 102. However, claimed subject matter is not limited to any particular described embodiments, implementations, examples, etc.

For certain example embodiments, a behavioral fingerprint 110, 110a, or 110b; an at least partially combined instantiation of at least two of a behavioral fingerprint 110, 110a, or 110b; a portion of a behavioral fingerprint 110, 110a, or 110b; or a combination thereof; etc. may be distributed across or stored at, by way of example only, one or more of: a user device 102A, a user device 102B, a user device 102C, a network 106 or node thereof, a server device 112A, a server device 112B, some combination thereof, or so forth. Additionally or alternatively, a behavioral fingerprint 110, 110a, or 110b; an at least partially combined instantiation of at least two of a behavioral fingerprint 110, 110a, or 110b; a portion of a behavioral fingerprint 110, 110a, or 110b; or a combination thereof; etc. may be transmitted, received, exchanged, or a combination thereof, etc., by way of example only, via one or more of: at least one network 106, one or more channels 108, some combination thereof, or so forth. A user device 102 or a server device 112 may transmit, receive, exchange, or a combination thereof, etc. at least a portion of a behavioral fingerprint 110, 110a, or 110b directly between or among devices 102 or 112 or indirectly via at least one node (not explicitly shown) of one or more networks 106. However, claimed subject matter is not limited to any particular described embodiments, implementations, examples, etc.

FIG. 2B is a schematic diagram 200B of multiple user devices, multiple server devices, and multiple example locations for at least a portion of at least one behavioral fingerprint in accordance with certain example embodiments. As shown in FIG. 2B, by way of example but not limitation, schematic diagram 200B may include at least one user device 102, at least one user 104, at least one network 106, at least one channel 108, at least one behavioral fingerprint 110, or at least one server device 112. More specifically, schematic diagram 200B may include, by way of example only, three user devices 102 (e.g., a user device 102A, a user device 102B, or a user device 102C, etc.), two server devices 112 (e.g., a server device 112A, or a server device 112B, etc.), or six behavioral fingerprints 110 (e.g., a behavioral fingerprint 110c, a behavioral fingerprint 110d, a behavioral fingerprint 110e, a behavioral fingerprint 110f, a behavioral fingerprint 110g, or a behavioral fingerprint 110h, etc.).

For certain example embodiments, a given behavioral fingerprint 110 or portion thereof may be located at (stored at, distributed at least partially across, accessible from, associated with, or a combination thereof, etc.) one or more devices 102 or 112. By way of example only, a behavioral fingerprint 110c may be located at a user device 102A, a behavioral fingerprint 110d may be located at a user device 102B, a behavioral fingerprint 110e may be located at a user device 102C, a behavioral fingerprint 110f may be located at a network 106 (e.g., at a cloud service or system), a behavioral fingerprint 110g may be located at a server device 112A, or a behavioral fingerprint 110h may be located at a server device 1128. For certain example implementations, any one or more of behavioral fingerprints 110c-110h may include one or more separate or individualized behavioral fingerprints 110; may include one or more combined, amalgamated, distributed, or a combination thereof, etc. behavioral fingerprints 110; may include at least a portion of at least one behavioral fingerprint 110; some combination thereof; or so forth. However, claimed subject matter is not limited to any particular described embodiments, implementations, examples, etc.

For certain example embodiments, at least one behavioral fingerprint 110 (e.g., of behavioral fingerprints 110c-110h) may be associated with at least one user 104 or one or more of user devices 102A, 1028, or 102C. For certain example implementations, a behavioral fingerprint 110c, which may be stored at a user device 102A, may be associated with a user 104 and user device 102A. For certain example implementations, a behavioral fingerprint 110g, which may be stored at a server device 112A, may be associated with a user 104 and a user device 102A. For certain example implementations, a behavioral fingerprint 110h, which may be stored at a server device 1128, may be associated with a user 104, a user device 1028, and a user device 102C. For certain example implementations, a behavioral fingerprint 110c, which may be stored at a user device 102A and associated therewith, and a behavioral fingerprint 110d, which may be stored at a user device 1028 and associated therewith, may be individually or jointly associated with a user 104. A behavioral fingerprint 110c and a behavioral fingerprint 110d may be identical to each other, partially the same, different from one another, updated to keep one at least partially coherent or consistent with the other, some combination thereof, or so forth. For certain example implementations, a behavioral fingerprint 110d, which may be stored at a user device 1028 and associated therewith, and a behavioral fingerprint 110g, which may be stored at a server device 112A and associated with a user device 102C, may be individually or jointly associated with a user 104. A behavioral fingerprint 110d and a behavioral fingerprint 110g may be identical to each other, partially the same, different from one another, updated to keep one at least partially coherent or consistent with the other, some combination thereof, or so forth. For certain example implementations, a behavioral fingerprint 110e, which may be stored at a user device 102C and associated therewith, and a behavioral fingerprint 110h, which may be stored at a server device 1126 and also associated with user device 102C, may be individually or jointly associated with a user 104. A behavioral fingerprint 110e and a behavioral fingerprint 110h may be identical to each other, partially the same, different from one another, updated to keep one at least partially coherent or consistent with the other, some combination thereof, or so forth. For certain example implementations, a behavioral fingerprint 110e, which may be stored at a user device 102C, may be associated with a user 104 and a user device 1026. Although each user device 102 and server device 112 (and network 106) is shown in schematic diagram 200B as having a behavioral fingerprint 110 located there at, one or more user devices 102 or server devices 112 (or networks 106) may alternatively not have a behavioral fingerprint 110 located there at. Furthermore, other additional or alternative approaches may instead be implemented.

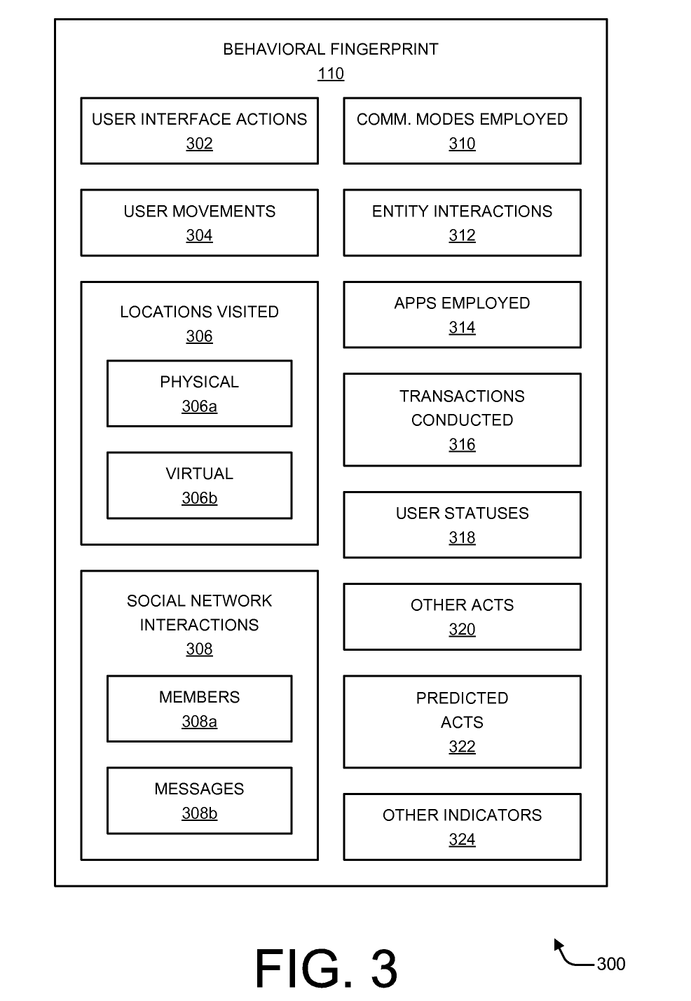

For certain example embodiments, a behavioral fingerprint 110 (including but not limited to any one or more of behavioral fingerprints 110a-110h) may include a whole behavioral fingerprint, a portion of a behavioral fingerprint, a behavioral fingerprint associated with a single user device, a behavioral fingerprint associated with multiple user devices, a part of a distributed behavioral fingerprint, a whole behavioral fingerprint that is distributed across multiple devices, a portion or a whole behavioral fingerprint that is located at one device, one or more indicators of one or more behavior-related acts, some combination thereof, or so forth. Examples of behavioral fingerprint(s) 110 are described further herein below with particular reference to FIG. 3. However, claimed subject matter is not limited to any particular described embodiments, implementations, examples, etc.

FIG. 3 is a schematic diagram 300 illustrating an example behavioral fingerprint including one or more example indicators of one or more behavior-related acts in accordance with certain example embodiments. As shown in FIG. 3, by way of example but not limitation, schematic diagram 300 may depict a behavioral fingerprint 110, which behavioral fingerprint 110 may include any one or more indicators of various acts 302-322 or other indicators 324. Example indicators 302-324 that are illustrated may include, but are not limited to, user interface actions 302, user movements 304, locations visited 306, social network interactions 308, communication modes employed 310, entity interactions 312, apps employed 314, transactions conducted 316, user statuses 318, other acts 320, predicted acts 322, other indicators 324, some combination thereof, or so forth. More specifically, locations visited 306 may include physical locations visited 306a, virtual locations visited 306b, or a combination thereof, etc., or social network interactions 308 may include social network members 308a, social network messages 308b, or a combination thereof, etc. Additional or alternative implementations to those of schematic diagram 300 for a behavioral fingerprint 110 are described further herein below as well as above. Moreover, a behavioral fingerprint 110 may alternatively include more, fewer, or different indicator(s) from those that are illustrated without departing from claimed subject matter.

For certain example embodiments, one or more user interface actions 302 may include, but are not limited to, a type of user interaction (e.g., buttons, keys, physical keyboard, touch screen, swipes, virtual buttons, virtual keyboard, multi-finger touch, speech, textual, movement sensing input such as a shake or a twist, or a combination thereof, etc.), a speed of user interaction (e.g., speech rate, speech cadence, typing speed, swiping speed, scrolling speed, speed moving between or among windows or apps, duration of a swipe or press of a virtual or physical key or button, or a combination thereof, etc.), a user input apparatus (e.g., a built-in microphone, a wireless microphone, a built-in keyboard, a virtual keyboard, a detachable/attachable keyboard, a wireless keyboard, an input apparatus identifiable such as by name or number, or a combination thereof, etc.), a position of user interaction (e.g., a location of touch for a touch-sensitive screen having a keyboard or button or swipe area, a location of a swipe, a length of a swipe, an offset from a designated key or slide area, or a combination thereof, etc.), a user output apparatus (e.g., a screen, a built-in speaker, a separate speaker, a vibration unit, an integrated output apparatus, a wired output apparatus, a wireless output apparatus, an output apparatus identifiable such as by name or number, or a combination thereof, etc.), some combination thereof, or so forth. However, claimed subject matter is not limited to any particular described embodiments, implementations, examples, etc.

For certain example embodiments, one or more user movements 304 may include, but are not limited to, device orientation (e.g., cardinal direction a device is pointed at, angle a device is held at, or a combination thereof, etc.), device shakes or deformations (e.g., how a device is moved to provide input, how a device is pressed or twisted or curved to provide input, or a combination thereof, etc.), a pattern of vibrations or jostling applied to or experienced by a device during daily use (e.g., as a result of carrying it, commuting with it, placing it in a pack or purse, placing it in a pocket, or a combination thereof, etc.), some combination thereof, or so forth. However, claimed subject matter is not limited to any particular described embodiments, implementations, examples, etc.

For certain example embodiments, one or more locations visited 306 may include, but are not limited to, locations that a user carries, sends, places, or travels with a device; locations that a user directs software to acquire data from or send data to; some combination thereof; or so forth. For certain example implementations, physical locations visited 306a may include, but are not limited to, an address, a room, a store, a building, a neighborhood, a city, a state, a country, one or more satellite positioning system (SPS) coordinates, a check-in location, a business, one or more geographical (e.g., cardinal) coordinates, a geographical zone (e.g., coordinates or approximate position in conjunction with a distance or range), some combination thereof, or so forth. For certain example implementations, virtual locations visited 306b may include, but are not limited to, an internet address, a web page, a web site, a social network, a destination within a social network, a virtual world, a destination within a virtual world, a chat room, a bulletin board, a blog, some combination thereof, or so forth. However, claimed subject matter is not limited to any particular described embodiments, implementations, examples, etc.

For certain example embodiments, one or more social network interactions 308 may include, but are not limited to, accessing a social network, reading a communication from one or more social network members, sending a communication to one or more social network members, changing profile or account information for a social network, viewing publicly-available social network information (e.g., viewing a person's wall, board, stream, pinning, or a combination thereof, etc.), viewing private social network information (e.g., viewing a targeted or personalized message, tweet, picture, or a combination thereof, etc.), searching for entities on a social network, playing games via a social network, experiencing entertainment (e.g., video, audio, clips, pictures, or a combination thereof, etc.) via a social network, a listing of which social network(s) are accessed, an order of which social networks are accessed, a day or time of accessing particular social network(s), some combination thereof, or so forth. For certain example implementations, social network member interactions 308a may include, but are not limited to, identifying or listing members interacted with via receiving, retrieving, sending, replying to or a combination thereof, etc. one or more communications; noting particular social network protocols or modes (e.g., wall writing or viewing, tweet sending or receiving, picture sending or viewing, public versus private communicating, or a combination thereof, etc.) used to communicate with particular members individually or in groups; noting particular social network protocols or modes used to communicate with particular member groups; some combination thereof; or so forth. For certain example implementations, social network message interactions 308b may include, but are not limited to, noting (e.g., recording, memorializing, storing, identifying, or a combination thereof, etc.) messages sent or received, noting an order of message sending or viewing, noting a type (e.g., a social network protocol) of message sent or received, noting a number of messages sent or received, noting a duration between arrival of a message (e.g., generally or from a particular member) and viewing of the message, noting a duration between arrival or viewing of a message (e.g., generally or from a particular member) and responding to the message, some combination thereof, or so forth. However, claimed subject matter is not limited to any particular described embodiments, implementations, examples, etc.

For certain example embodiments, one or more communication modes employed 310 may include, but are not limited to, speech, a phone call, a voice-over-internet-protocol (VoIP) communication, text messaging, instant messaging, a video communication (e.g., a video call, a video conference, or a combination thereof, etc.), a social-network-based communication (e.g., a communication that is effectuated at least partially using a social network app, web site, service, or a combination thereof, etc.), some combination thereof, or so forth. Additionally or alternatively, one or more communication modes employed 310 may include, but are not limited to, indicators of which communication mode is employed if/when responding to a received communication of a given communication mode (e.g., it may be noted that an authorized user may respond to most phone calls or phone calls from particular people with text messages). However, claimed subject matter is not limited to any particular described embodiments, implementations, examples, etc.

For certain example embodiments, one or more entity interactions 312 may include, but are not limited to, identification of at least one entity (e.g., business, service, person, social network member, group, organization, or a combination thereof, etc.) that a user interacts with (e.g., with or without an indicator of a communication mode, such as via a telephone capability, via email, via instant messaging, via a social network communication protocol, via VoIP, via a video capability, via a speech capability, or a combination thereof, etc.), a listing of entities interacted with, an order of entities interacted with, notations of when (e.g., a day, a time, days of week, or a combination thereof, etc.) entities are interacted with, notations of how (e.g., a communication mode used, a duration, or a combination thereof, etc.) entities are interacted with, some combination thereof, or so forth. However, claimed subject matter is not limited to any particular described embodiments, implementations, examples, etc.

For certain example embodiments, one or more apps employed 314 may include, but are not limited to, identification of one or more apps (e.g., applications, native applications, downloaded applications, installed applications, software applications, web applications, or a combination thereof, etc.) employed (e.g., accessed, started, opened, launched, viewed, consulted, manipulated, configured, installed, executed, or a combination thereof, etc.) by a user, a listing of apps employed, an order of apps employed, a notation of a time or a day at which apps are employed, a notation of duration(s) for which apps are employed, some combination thereof, or so forth. However, claimed subject matter is not limited to any particular described embodiments, implementations, examples, etc.

For certain example embodiments, one or more transactions conducted 316 may include, but are not limited to, an identification of transactions (e.g., exchanges of consideration, purchases, orders, downloads, or a combination thereof, etc.) conducted (e.g., initiated, requested, consummated, effectuated, accomplished, monitored, or a combination thereof, etc.), a list of transactions, a notation of times or days of transactions, a notation of transaction amounts, a notation of at least one party to one or more transactions, a notation of items (e.g., physical items such as food or electronics, virtual items such as songs or movies or games or in-game abilities, or a combination thereof, etc.) or services (e.g., physical services such as a massage or a car wash, virtual services such as streaming media or a membership, or a combination thereof, etc.) involved in one or more transactions, some combination thereof, or so forth. However, claimed subject matter is not limited to any particular described embodiments, implementations, examples, etc.

For certain example embodiments, one or more user statuses 318 may include, but are not limited to, a location status update, a health status update, an alert (e.g., as to whether a person has possession or has lost possession of a device; as to whether a device has exceeded some percentage—e.g. 50% or 75% or 100%—of an allotted amount, such as of minutes of talking, bytes of data, messages of texting, dollars of a fund, time of use, etc.; as to where a person is currently located; a combination thereof; etc.), a current (e.g., most recent, present, or a combination thereof, etc.) activity update, some combination thereof, or so forth. However, claimed subject matter is not limited to any particular described embodiments, implementations, examples, etc.

For certain example embodiments, one or more other acts 320 may include, but are not limited to, other user behaviors, user habits, user actions, user movements, user interactions, user visitations, user transactions, device features (e.g., capabilities, native applications, operating system functions, or a combination thereof, etc.) employed, or a combination thereof, etc. that a device may monitor (e.g., detect, observe, discern, ascertain, or a combination thereof, etc.); other acts reflecting user behavior; other acts described herein; some combination thereof; or so forth. However, claimed subject matter is not limited to any particular described embodiments, implementations, examples, etc.

For certain example embodiments, one or more predicted acts 322 may include, but are not limited to, an act that is predicted based at least partially on any one or more of other indicators 302-320; an act that is predicted to be performed by an authorized user; an act corresponding to a particular likelihood level of re-occurring; an act that is predicted to re-occur in view of one or more observed acts of at least one authorized user of one or more user devices; an act that is predicted to occur based at least partially on a statistical analysis (e.g., a likelihood function, a histogram evaluation, a probabilistic approach, a Bayesian analysis, a stochastic mechanism, a correlation procedure, a probability density function, a normal/Gaussian distribution, a cumulative distribution function, an expected value, or a combination thereof, etc.) of one or more historically-monitored acts; an act that has been repeatedly performed in certain manner(s) or at particular time(s) such that it can be expected to be performed again in such certain manner(s) or at such particular time(s); an act that is derived or results from a conversion of monitored act(s) corresponding to one device to at least one act corresponding to another device; some combination thereof; or so forth. However, claimed subject matter is not limited to any particular described embodiments, implementations, examples, etc.

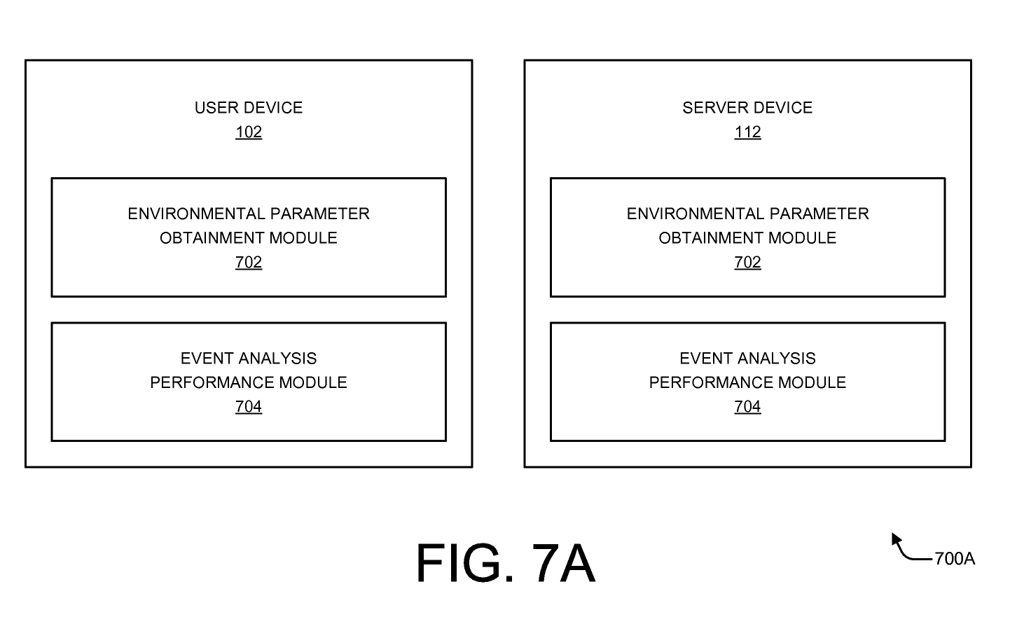

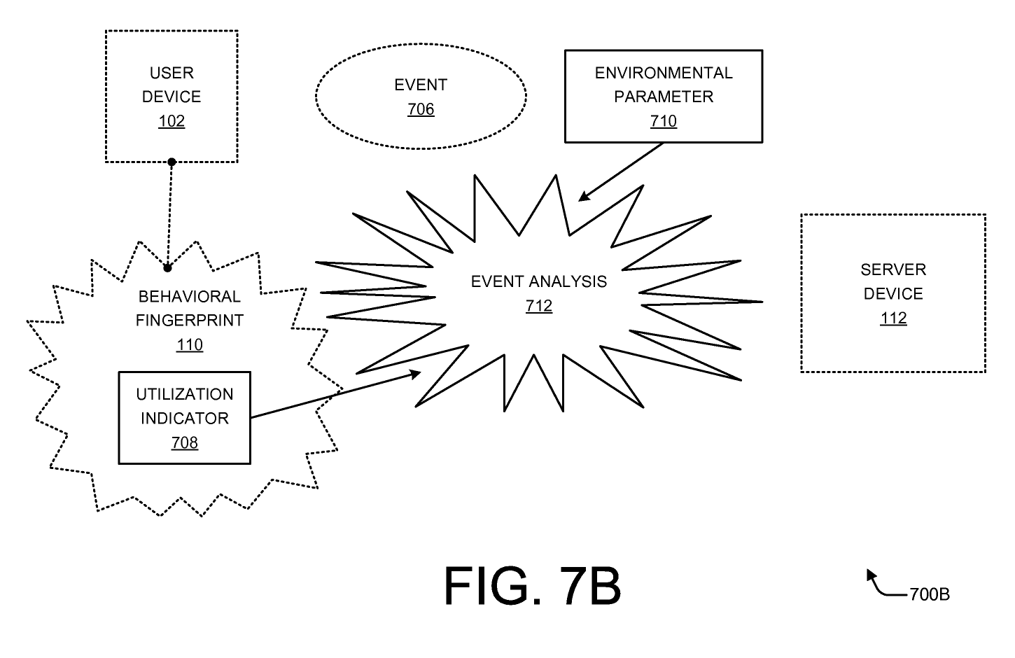

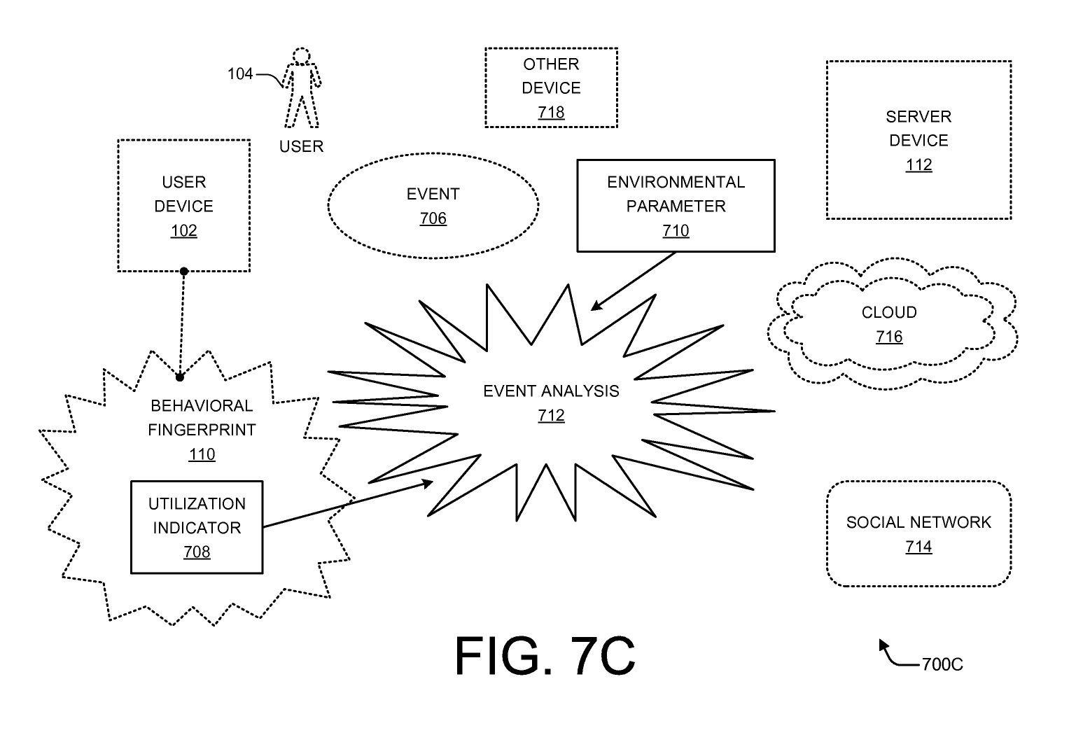

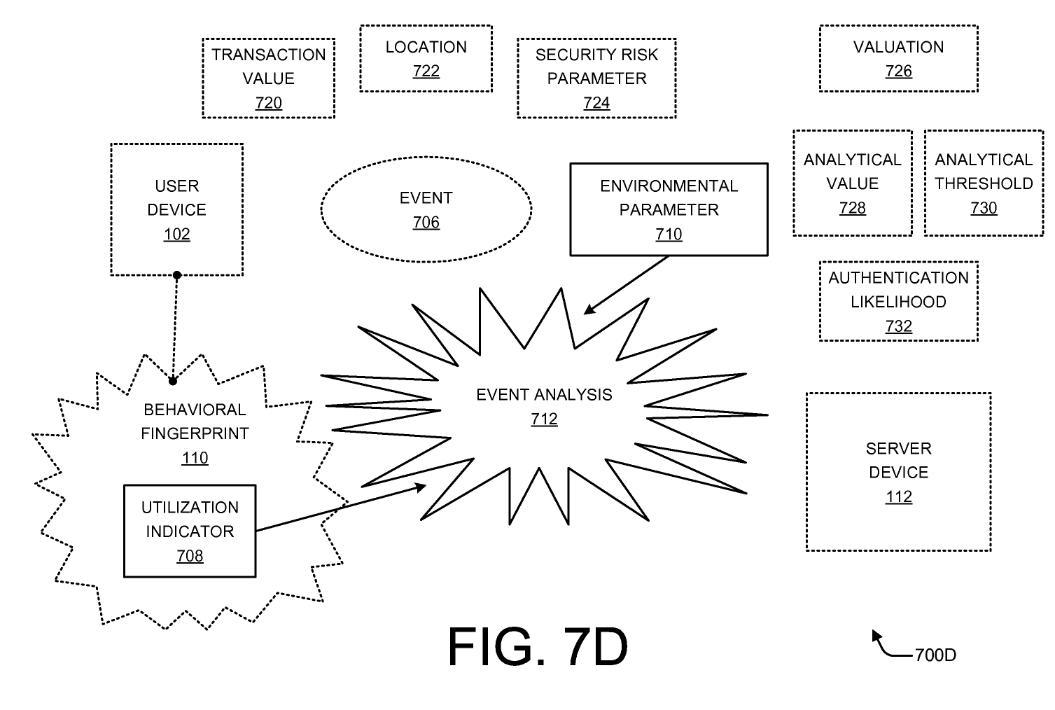

For certain example embodiments, one or more other indicators 324 may include, but are not limited to, static characteristics of an authorized user, individuals that are related to an authorized user, characteristics of individuals that are related to an authorized user; nature of relationships between or among an authorized user and other individuals, some combination thereof, or so forth. Non-exhaustive examples of other indicators 324 are provided herein below with particular reference to FIG. 7A-7D, 8A-8D, 9A-9D, or 10A-10B. However, claimed subject matter is not limited to any particular described embodiments, implementations, examples, etc.

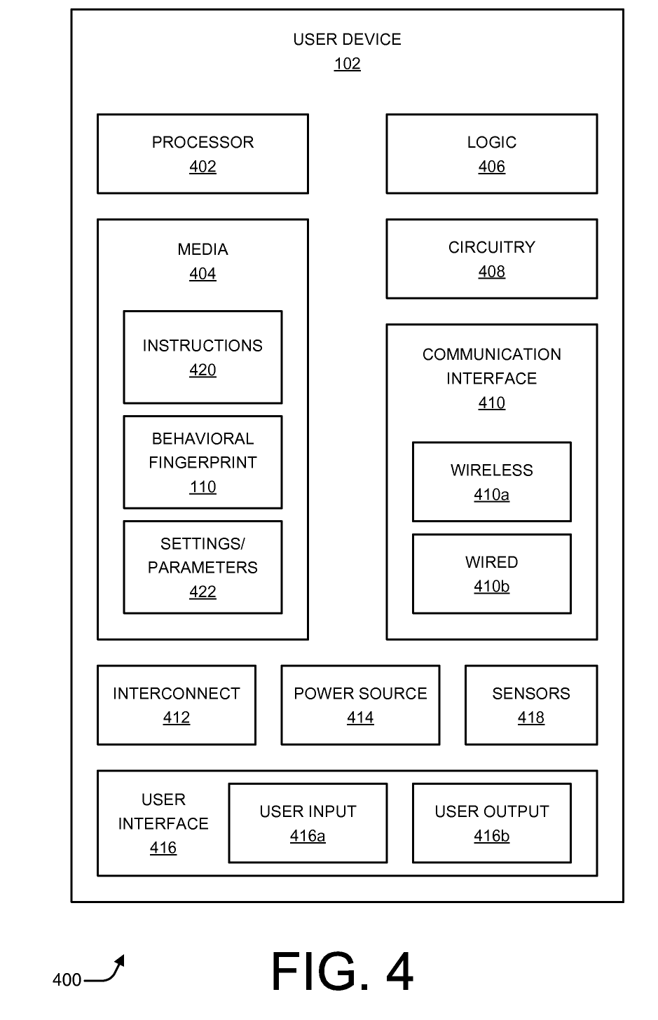

FIG. 4 is a schematic diagram 400 of an example user device including one or more example components in accordance with certain example embodiments. As shown in FIG. 4, a user device 102 may include one or more components such as: at least one processor 402, one or more media 404, logic 406, circuitry 408, at least one communication interface 410, at least one interconnect 412, at least one power source 414, at least one user interface 416, one or more sensors 418, some combination thereof, or so forth. Furthermore, as shown in schematic diagram 400, one or more media 404 may include one or more instructions 420, at least one behavioral fingerprint 110, one or more settings or parameters 422, some combination thereof, or so forth; a communication interface 410 may include at least one wireless communication interface 410a, at least one wired communication interface 410b, some combination thereof, or so forth; or a user interface 416 may include at least one user input interface 416a, at least one user output interface 416b, some combination thereof, or so forth. However, a user device 102 may alternatively include more, fewer, or different component(s) from those that are illustrated without departing from claimed subject matter.

For certain example embodiments, a user device 102 may include or comprise at least one electronic device. User device 102 may include, for example, a computing platform or any electronic device having at least one processor or memory. Processor 402 may include, by way of example but not limitation, any one or more of a general-purpose processor, a specific-purpose processor, a digital signal processor (DSP), a processing unit, some combination thereof, or so forth. A processing unit may be implemented, for example, with one or more application specific integrated circuits (ASICs), DSPs, digital signal processing devices (DSPDs), programmable logic devices (PLDs), field programmable gate arrays (FPGAs), processors generally, processing cores, discrete/fixed logic circuitry, controllers, micro-controllers, microprocessors, some combination thereof, or so forth. Media 404 may bear, store, contain, include, provide access to, or a combination thereof, etc. instructions 420, which may be executable by a processor 402; at least one behavioral fingerprint 110; one or more settings/parameters 422; some combination thereof; or so forth. Instructions 420 may include or comprise, by way of example but not limitation, a program, a module, an application or app (e.g., that is native, that runs in a browser, that runs within a virtual machine, or a combination thereof, etc.), an operating system, or a combination thereof, etc. or portion thereof; operational data structures; source code, object code, just-in-time (JIT) compiled code, or a combination thereof, etc.; processor-executable instructions; other code; some combination thereof; or so forth. Media 404 may include, by way of example but not limitation, processor-accessible or non-transitory media (e.g., memory, random access memory (RAM), read only memory (ROM), flash memory, hard drives, disk-based media, disc-based media, magnetic storage, optical storage, volatile memory, nonvolatile memory, or a combination thereof, etc.) that is capable of bearing instructions, a behavioral fingerprint, settings, parameters, some combination thereof, or so forth.

For certain example embodiments, execution of instructions 420 by one or more processors 402 may transform user device 102 into a special-purpose computing device, apparatus, platform, machine, some combination thereof, or so forth. Instructions 420 may include, for example, instructions that are capable of realizing at least a portion of one or more flow diagrams, methods, processes, procedures, operations, functionality, technology, mechanisms, or a combination thereof, etc. that are described herein or illustrated in the accompanying drawings. Settings/parameters 422 may include, by way of example but not limitation, one or more settings or parameters that may be established or determined by a user or other entity, one or more or settings or parameters that may be determined or detected by a user device 102, one or more settings or parameters that may be received from another device that determined or detected them, one or more settings or parameters that may determine at least partly how a user device 102 is to operate or respond to a situation or a behavioral fingerprint, one or more settings or parameters (e.g., values) that may be used to realize flow diagrams, methods, processes, procedures, operations, functionality, technology, mechanisms, or a combination thereof, etc. that are described herein or illustrated in the accompanying drawings. Settings/parameters 422 may control at least partially how at least one behavioral fingerprint 110 is configured, stored, shared, used, applied, some combination thereof, or so forth. Additionally or alternatively, at least a portion of settings/parameters 422 may be at least partially integrated with at least one behavioral fingerprint 110.

For certain example embodiments, logic 406 may include hardware, software, firmware, discrete/fixed logic circuitry, or a combination thereof, etc. that is capable of performing or facilitating performance of flow diagrams, methods, processes, procedures, operations, functionality, technology, mechanisms, or a combination thereof, etc. that are described herein or illustrated in the accompanying drawings. Circuitry 408 may include hardware, software, firmware, discrete/fixed logic circuitry, or a combination thereof, etc. that is capable of performing or facilitating performance of flow diagrams, methods, processes, procedures, operations, functionality, technology, mechanisms, or a combination thereof, etc. that are described herein or illustrated in the accompanying drawings, wherein circuitry 408 includes at least one physical or hardware component or aspect.

For certain example embodiments, one or more communication interfaces 410 may provide one or more interfaces between user device 102 and another device or a person/operator. With respect to a person/operator, a communication interface 410 may include, by way of example but not limitation, a screen, a speaker, a keyboard or keys, a microphone, or other person-device input/output apparatuses. A wireless communication interface 410a or a wired communication interface 410b may also or alternatively include, by way of example but not limitation, a transceiver (e.g., a transmitter or a receiver), a radio, an antenna, a wired interface connector or other similar apparatus (e.g., a network connector, a universal serial bus (USB) connector, a proprietary connector, a Thunderbolt® or Light Peak® connector, or a combination thereof, etc.), a physical or logical network adapter or port, a frequency converter, a baseband processor, or a combination thereof, etc. to communicate wireless signals or wired signals via one or more wireless communication links or wired communication links, respectively, such as over at least one channel 108 (e.g., of FIGS. 1 and 2A). Communications with at least one communication interface 410 may enable transmitting, receiving, or initiating of transmissions, just to name a few examples.

For certain example embodiments, at least one interconnect 412 may enable signal communication between or among components of user device 102. Interconnect 412 may include, by way of example but not limitation, one or more buses, channels, switching fabrics, some combination thereof, or so forth. Although not explicitly illustrated in FIG. 4, one or more components of user device 102 may be coupled to interconnect 412 via a discrete or integrated interface. By way of example only, one or more interfaces may couple a communication interface 410 or a processor 402 to at least one interconnect 412. For certain example embodiments, at least one power source 414 may provide power to one or more components of user device 102. Power source 414 may include, by way of example but not limitation, a battery, a power connector, a solar power source or charger, a mechanical power source or charger, a fuel source, some combination thereof, or so forth.

For certain example embodiments, at least one sensor 418 may sense, produce, or otherwise provide at least one sensor value. Sensors 418 may include, by way of example only, a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), some combination thereof, or so forth. Values provided by at least one sensor 418 may include, by way of example but not limitation, an image, a sound recording, an acceleration value, a temperature, SPS coordinates, a barometric pressure, a humidity level, a compass direction, a gyroscopic value, a magnetic reading, a pressure value, an oscillation value, an ambient light reading, inertial readings, touch detections, finger placements, flex detections, some combination thereof, or so forth.

For certain example embodiments, a user interface 416 may enable one or more users to interact with user device 102. Interactions between a user and a user device may relate, by way of example but not limitation: to touch/tactile/feeling/haptic sensory (e.g., a user may shake, rotate, decline/incline, bend, twist, or move a user device which may be detected by a gyroscope, an accelerometer, a compass, or a combination thereof, etc.; a user may press a button, slide a switch, rotate a knob, etc.; a user may touch a touch-sensitive screen; a device may vibrate; some combination thereof; or so forth), to sound/hearing/speech sensory (e.g., a user may speak into a microphone, a device may generate sounds via a speaker, or a combination thereof, etc.), to sights/vision sensory (e.g., a device may activate one or more lights, modify an image presented on a display screen, or a combination thereof, etc.), some combination thereof, or so forth.

For certain example embodiments, a user interface 416 may include a user input interface 416a, a user output interface 416b, some combination thereof, or so forth. A user input interface 416a may include, by way of example but not limitation, a microphone, a button, a switch, a dial, a knob, a wheel, a trackball, a key, a keypad, a keyboard, a touch-sensitive screen, a touch-sensitive surface, a camera, a gyroscope, an accelerometer, a compass, a virtual button/slider/keyboard/etc. presented on a touch-sensitive screen, some combination thereof, or so forth. A user output interface 416b may include, by way of example but not limitation, a speaker, a screen (e.g., with or without touch-sensitivity), a vibrating haptic feature, some combination thereof, or so forth. Certain user interfaces 416 may enable both user input and user output. For example, a touch-sensitive screen may be capable of providing user output and accepting user input. Additionally or alternatively, a user interface 416 component (e.g., that may be integrated with or separate from a user device 102), such as a headset that has a microphone and a speaker, may enable both user input and user output.

However, claimed subject matter is not limited to any particular described embodiments, implementations, examples, or so forth. For instance, it should be understood that for certain example implementations components that are illustrated separately in FIG. 4 may not necessarily be separate or mutually exclusive. For example, a given component may provide multiple functionalities. By way of example only, a single component such as a USB connector may function as a wired communication interface 410b or a power source 414. Additionally or alternatively, a single component such as a display screen may function as a communication interface 410 with respect to a user, as a user input interface 416a, or as a user output interface 416b. Additionally or alternatively, one or more instructions 420 may function to realize at least part of a behavioral fingerprint 110 or at least one setting or parameter 422.

It should also be understood that for certain example implementations components that are illustrated in schematic diagram 400 or described herein may or may not be integral with or integrated into a user device 102. For example, a component may be removably connected to a user device 102, a component may be wirelessly coupled to a user device 102, some combination thereof, or so forth. By way of example only, instructions 420 may be stored on a removable card having at least one medium 404. Additionally or alternatively, a user interface 416 (e.g., a wired or wireless headset, a screen, a video camera, a keyboard, or a combination thereof, etc.) may be coupled to a user device 102 wirelessly or by wire. However, claimed subject matter is not limited to any particular described embodiments, implementations, examples, etc.

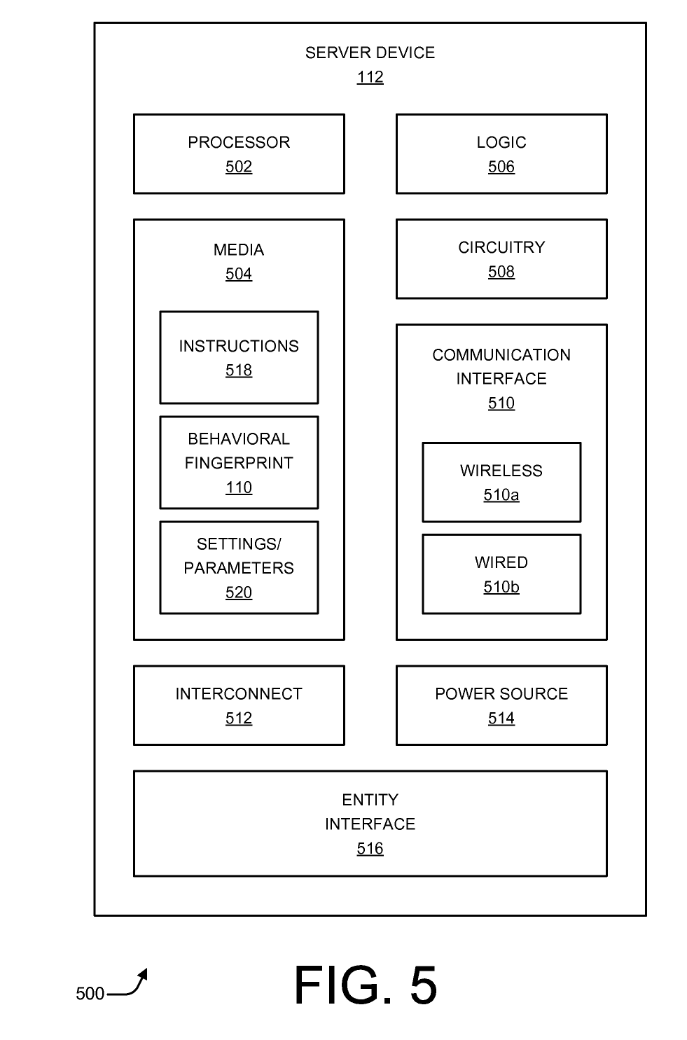

FIG. 5 is a schematic diagram 500 of an example server device including one or more example components in accordance with certain example embodiments. As shown in FIG. 5, a server device 112 may include one or more components such as: at least one processor 502, one or more media 504, logic 506, circuitry 508, at least one communication interface 510, at least one interconnect 512, at least one power source 514, at least one entity interface 516, some combination thereof, or so forth. Furthermore, as shown in schematic diagram 500, one or more media 504 may include one or more instructions 518, at least one behavioral fingerprint 110, one or more settings or parameters 520, some combination thereof, or so forth; or communication interface 510 may include at least one wireless communication interface 510a, at least one wired communication interface 510b, some combination thereof, or so forth. However, a server device 112 may alternatively include more, fewer, or different component(s) from those that are illustrated without departing from claimed subject matter.

For certain example embodiments, a server device 112 may include or comprise at least one processing or computing device or machine. Server device 112 may include or comprise, for example, a computing platform or any electronic device or devices having at least one processor or memory. Processor 502 may include, by way of example but not limitation, any one or more of a general-purpose processor, a specific-purpose processor, a digital signal processor (DSP), a processing unit, some combination thereof, or so forth. A processing unit may be implemented, for example, with one or more application specific integrated circuits (ASICs), DSPs, digital signal processing devices (DSPDs), programmable logic devices (PLDs), field programmable gate arrays (FPGAs), processors generally, processing cores, discrete/fixed logic circuitry, controllers, micro-controllers, microprocessors, some combination thereof, or so forth. Media 504 may bear, store, contain, include, provide access to, or a combination thereof, etc. instructions 518, which may be executable by a processor 502; at least one behavioral fingerprint 110; one or more settings/parameters 520; some combination thereof; or so forth. Instructions 518 may include or comprise, by way of example but not limitation, a program, a module, an application or app (e.g., that is native, that runs in a browser, that runs within a virtual machine or server, or a combination thereof, etc.), an operating system, or a combination thereof, etc. or portion thereof; operational data structures; source code, object code, just-in-time (JIT) compiled code, or a combination thereof, etc.; processor-executable instructions; other code; some combination thereof; or so forth. Media 504 may include, by way of example but not limitation, processor-accessible or non-transitory media (e.g., memory, random access memory (RAM), read only memory (ROM), flash memory, hard drives, disk-based media, disc-based media, magnetic storage, optical storage, volatile memory, nonvolatile memory, or a combination thereof, etc.) that is capable of bearing instructions, at least one behavioral fingerprint, settings, parameters, some combination thereof, or so forth.

For certain example embodiments, execution of instructions 518 by one or more processors 502 may transform server device 112 into a special-purpose computing device, apparatus, platform, machine, some combination thereof, or so forth. Instructions 518 may include, for example, instructions that are capable of realizing at least a portion of one or more flow diagrams methods, processes, procedures, operations, functionality, technology, mechanisms, or a combination thereof, etc. that are described herein or illustrated in the accompanying drawings. Settings/parameters 520 may include, by way of example but not limitation, one or more settings or parameters that may be established by a user or other entity, one or more settings or parameters that may be determined by a server device 112, one or more settings or parameters that may be determined by a user or other entity, one or more settings or parameters that may be detected by a server device 112, one or more settings or parameters that may be received from another device that detected them, one or more settings or parameters that may determine at least partly how a server device 112 is to operate or respond to a situation or a behavioral fingerprint, one or more settings or parameters (e.g., values) that may be used to realize flow diagrams, methods, processes, procedures, operations, functionality, technology, mechanisms, or a combination thereof, etc. that are described herein or illustrated in the accompanying drawings. Settings/parameters 520 may control at least partially how at least one behavioral fingerprint 110 is configured, stored, shared, used, applied, some combination thereof, or so forth. Additionally or alternatively, at least a portion of settings/parameters 520 may be at least partially integrated with at least one behavioral fingerprint 110.

For certain example embodiments, logic 506 may include hardware, software, firmware, discrete/fixed logic circuitry, or a combination thereof, etc. that is capable of performing or facilitating performance of flow diagrams, methods, processes, procedures, operations, functionality, technology, mechanisms, or a combination thereof, etc. that are described herein or illustrated in the accompanying drawings. Circuitry 508 may include hardware, software, firmware, discrete/fixed logic circuitry, or a combination thereof, etc. that is capable of performing or facilitating performance of flow diagrams, methods, processes, procedures, operations, functionality, technology, mechanisms, or a combination thereof, etc. that are described herein or illustrated in the accompanying drawings, wherein circuitry 508 includes at least one physical or hardware component or aspect.

For certain example embodiments, one or more communication interfaces 510 may provide one or more interfaces between server device 112 and another device or a person/operator/entity directly or indirectly. A wireless communication interface 510a or a wired communication interface 510b may also or alternatively include, by way of example but not limitation, a transceiver (e.g., a transmitter or a receiver), a radio, an antenna, a wired interface connector or other similar apparatus (e.g., a network connector, a universal serial bus (USB) connector, a proprietary connector, a Thunderbolt® or Light Peak® connector, a gateway, or a combination thereof, etc.), a physical or logical network adapter or port, a frequency converter, a baseband processor, an internet or telecommunications backbone connector, a fiber optic connector, a storage area network (SAN) connector, or a combination thereof, etc. to communicate wireless signals or wired signals via one or more wireless communication links or wired communication links, respectively, such as over one or more channels 108 (e.g., of FIGS. 1 and 2A). Communications with at least one communication interface 510 may enable transmitting, receiving, or initiating of transmissions, just to name a few examples.

For certain example embodiments, at least one interconnect 512 may enable signal communication between or among components of server device 112. Interconnect 512 may include, by way of example but not limitation, one or more buses, channels, switching fabrics, local area networks (LANs), storage area networks (SANs), some combination thereof, or so forth. Although not explicitly illustrated in FIG. 5, one or more components of server device 112 may be coupled to interconnect 512 via a discrete or integrated interface. By way of example only, one or more interfaces may couple a processor 502 or a medium 504 to at least one interconnect 512. For certain example embodiments, at least one power source 514 may provide power to one or more components of server device 112. Power source 514 may include, by way of example but not limitation, a power connector for accessing an electrical grid, a fuel cell, a solar power source, some combination thereof, or so forth.

For certain example embodiments, an entity interface 516 may enable one or more entities (e.g., another device, a person, a group, a robotic entity, or a combination thereof, etc.) to provide input to or receive output from server device 112. Interactions between an entity and a device may relate, by way of example but not limitation, to inputting or outputting instructions, commands, settings, parameters, indications or indicators, some combination thereof, or so forth. Certain entity interfaces 516 may enable both entity input and entity output at server device 112 or over at least one network link, such as one or more channels 108 (e.g., of FIGS. 1 and 2A).

However, claimed subject matter is not limited to any particular described embodiments, implementations, examples, or so forth. For instance, it should be understood that for certain example implementations components that are illustrated separately in FIG. 5 need not necessarily be separate or mutually exclusive. For example, a given component may provide multiple functionalities. By way of example only, hard-wired logic 506 may form circuitry 508. Additionally or alternatively, a single component such as a connector may function as a communication interface 510 or as an entity interface 516. Additionally or alternatively, one or more instructions 518 may function to realize at least one setting or parameter 520.

It should also be understood that for certain example implementations components that are illustrated in schematic diagram 500 or described herein may not be integral or integrated with a server device 112. For example, a component may be removably connected to a server device 112, a component may be wirelessly coupled to a server device 112, one or more components of a server device 112 may be geographically distributed or separated from one another, some combination thereof, or so forth. By way of example only, instructions 518 may be stored on one medium 504, and settings/parameters 520 (or another portion of instructions 518) may be stored on a different medium 504, which may include a same server or a part of a different server of, e.g., a server farm. Additionally or alternatively, respective processor-media sets may be physically realized on different or respective server blades or server containers. Multiple server blades, for instance, may be linked or interlinked to realize at least one server device 112. However, claimed subject matter is not limited to any particular described embodiments, implementations, examples, etc.

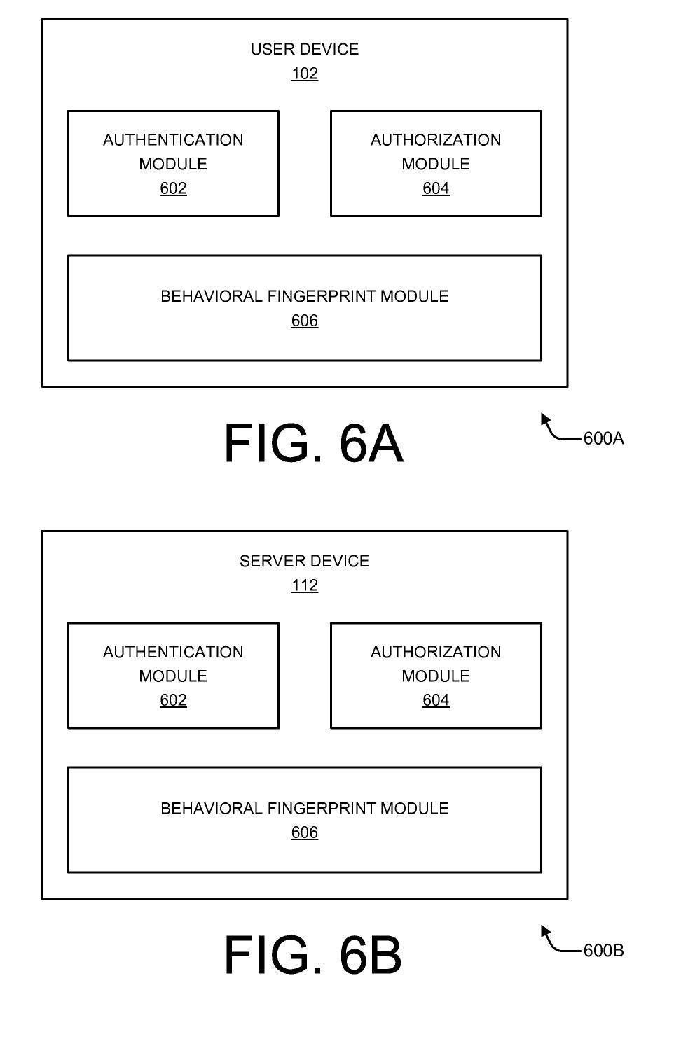

FIGS. 6A and 6B are schematic diagrams 600A and 600B of an example user device and an example server device, respectively, that have one or more functional modules in accordance with certain example embodiments. As shown in FIGS. 6A and 6B, by way of example but not limitation, schematic diagrams 600A and 600B may depict a user device 102 and a server device 112, respectively. As illustrated in schematic diagrams 600A and 600B, a user device 102 or a server device 112 may include, but are not limited to, at least one authentication module 602, at least one authorization module 604, at least one behavioral fingerprint module 606, a combination thereof, or so forth. However, a user device 102 or a server device 112 may alternatively include more, fewer, or different module(s) from those that are illustrated without departing from claimed subject matter.

For certain example embodiments, a module may include or be comprised of at least one processor (e.g., a processor 402 of FIG. 4, a processor 502 of FIG. 5, or a combination thereof, etc.), one or more media (e.g., a medium 404 of FIG. 4, a media medium 504 of FIG. 5, or a combination thereof, etc.), executable instructions (e.g., processor-executable instructions, instructions 420 of FIG. 4, instructions 518 of FIG. 5, computer-implementable instructions, or a combination thereof, etc.), logic (e.g., logic 406 of FIG. 4, logic 506 of FIG. 5, or a combination thereof, etc.), circuitry (e.g., circuitry 408 of FIG. 4, circuitry 508 of FIG. 5, or a combination thereof, etc.), other described or illustrated component(s), some combination thereof, or so forth. For certain example implementations, one or more modules (e.g., an authentication module 602, an authorization module 604, a behavioral fingerprint module 606, or a combination thereof, etc.) of at least one user device 102 may function or interoperate with one or more modules of at least one server device 112. However, claimed subject matter is not limited to any particular described embodiments, implementations, examples, etc.

For certain example embodiments, an authentication module 602 may operate to authenticate a user of a device. For certain example implementations, a user of a device may be authenticated by determining to some (e.g., reasonable, acceptable, measurable, quantifiable, or a combination thereof, etc.) degree an identity of a user. By way of example but not limitation, an authentication module 602 may enable implementation of multiple degrees of authentication, with different degrees of authentication corresponding to different levels of certainty of an identity of a user. Example aspects related to authentication are described further herein (e.g., at least herein above with particular reference to FIG. 1). However, claimed subject matter is not limited to any particular described embodiments, implementations, examples, etc.

For certain example embodiments, an authorization module 604 may operate to permit or enable full or at least partial access to, use of, implementation of, execution of, or a combination thereof, etc. one or more features, applications, accounts, profiles, data, capabilities, or a combination thereof, etc. of at least one device, such as a user device 102 or a server device 112. For certain example implementations, authorization may be fully or at least partially granted, denied, withheld, or a combination thereof, etc. based at least partially on an authentication determination, a result from an authentication module 602, some combination thereof, or so forth. By way of example but not limitation, an authorization module 604 may provide for different levels of authorization, including but not limited to those for a given authorized user, that correspond to different degrees of authentication, that correspond to different user identities, some combination thereof, or so forth. Example aspects related to authorization are described further herein (e.g., at least herein above with particular reference to FIG. 1). However, claimed subject matter is not limited to any particular described embodiments, implementations, examples, etc.

For certain example embodiments, a behavioral fingerprint module 606 may operate to implement, perform, facilitate performance of, or a combination thereof, etc. one or more flow diagrams, methods, processes, procedures, operations, functionality, technology, modules, mechanisms, or a combination thereof, etc. that are described herein or illustrated in the accompanying drawings or that relate to at least one behavioral fingerprint. For certain example implementations, a behavioral fingerprint module 606 may provide information, monitored acts, likelihood values, determinations, comparisons, analyses, indications or indicators, predicted acts, or a combination thereof, etc. to an authentication module 602 on which it may at least partially base an authentication determination. Example aspects related to behavioral fingerprinting are described further herein above and below. However, claimed subject matter is not limited to any particular described embodiments, implementations, examples, etc.

FIG. 7A is a schematic diagram 700A that includes at least one example device that is capable of handling scenarios for environmentally-responsive behavioral fingerprinting in accordance with certain example embodiments. As shown in FIG. 7A, by way of example but not limitation, schematic diagram 700A includes at least one device that may include an environmental parameter obtainment module 702 or an event analysis performance module 704. More specifically, schematic diagram 700A may include a user device 102 or a server device 112. By way of example but not limitation, an environmental parameter obtainment module 702 or an event analysis performance module 704 may include or comprise or be realized with at least one processor that executes instructions (e.g., sequentially, in parallel, at least partially overlapping in a time-multiplexed fashion, at least partially across multiple cores, or a combination thereof, etc.) as at least one special-purpose computing component, or otherwise as described herein. However, claimed subject matter is not limited to any particular described embodiments, implementations, examples, etc.

For certain example embodiments, an environmental parameter obtainment module 702 or an event analysis performance module 704 may be implemented separately or at least partially jointly or in combination. An environmental parameter obtainment module 702 may be configured to obtain at least one environmental parameter relating to an event to potentially occur in conjunction with at least one user device. An event analysis performance module 704 may be configured to perform at least one analysis for an event based at least partially on at least one environmental parameter and at least partially on at least one utilization indicator of a behavioral fingerprint that is associated with at least one user device. However, claimed subject matter is not limited to any particular described embodiments, implementations, examples, etc.

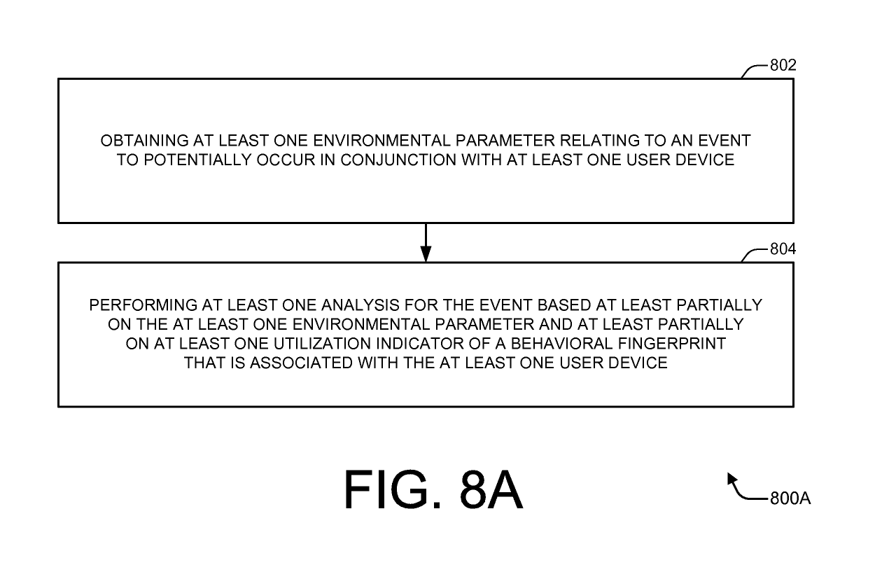

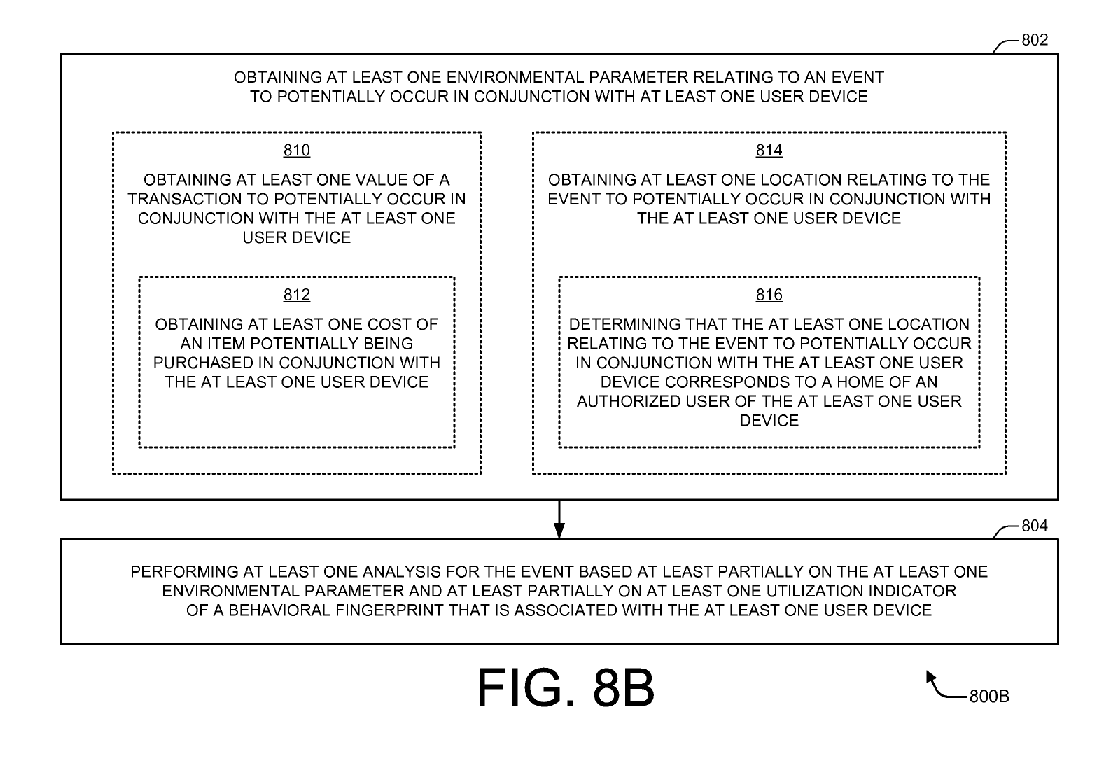

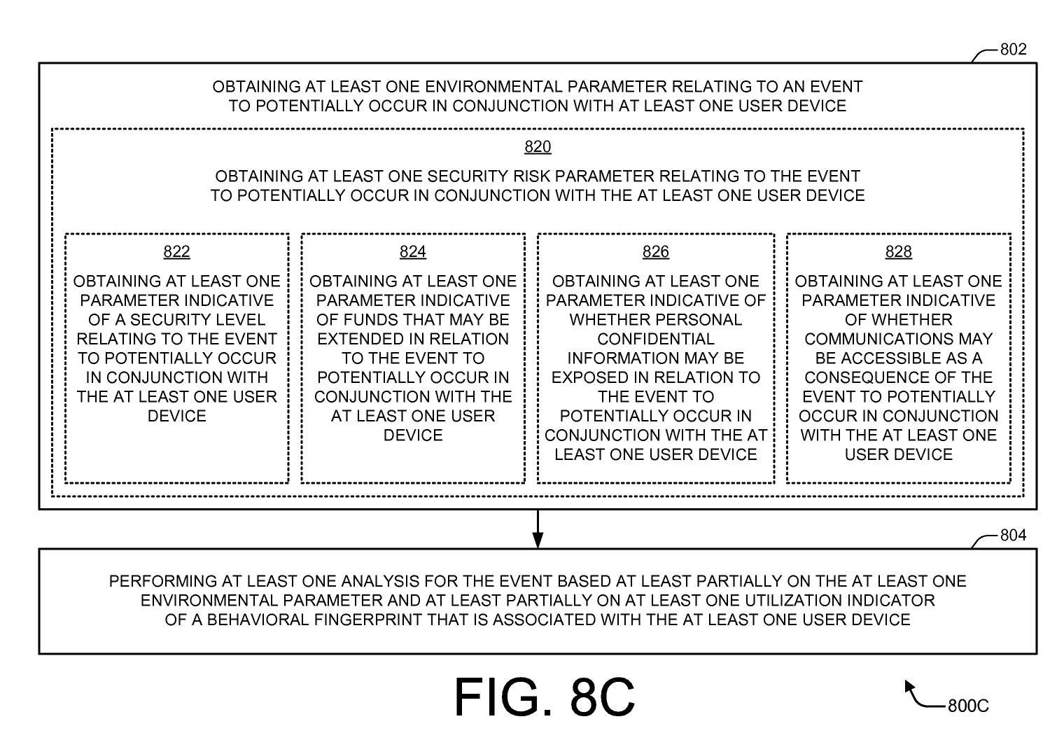

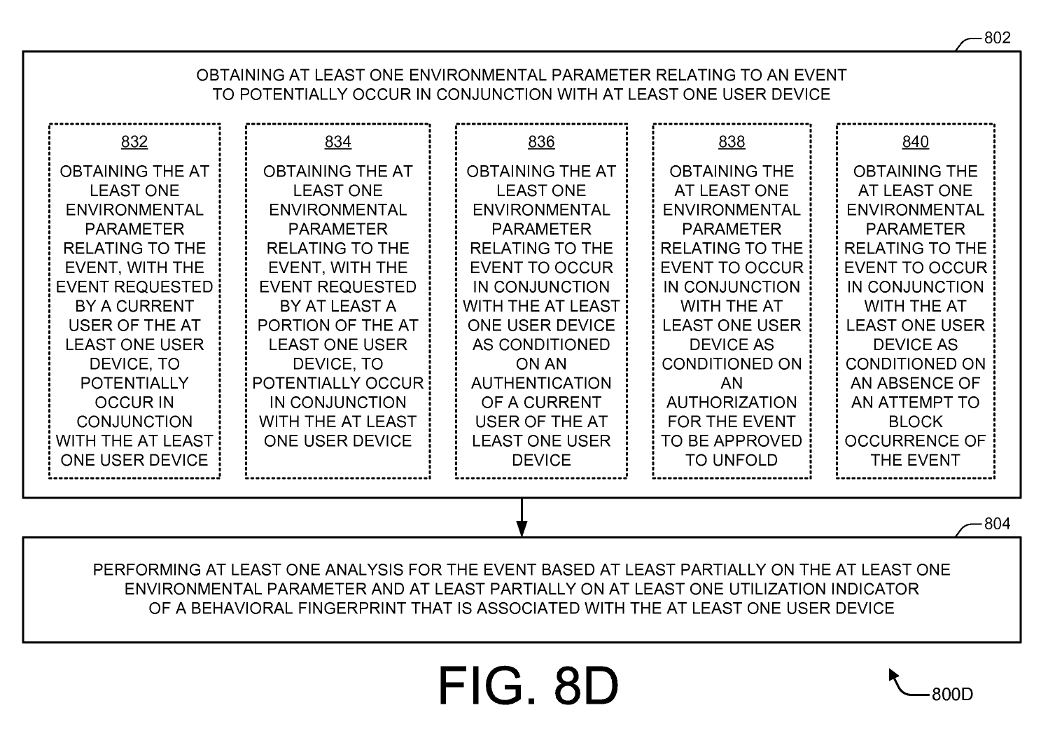

FIGS. 7B-7D are schematic diagrams 700B-700D that include at least one example device and that depict example scenarios for implementing environmentally-responsive behavioral fingerprinting in accordance with certain example embodiments. As shown in FIGS. 7B-7D, by way of example but not limitation, one or more of schematic diagrams 700B-700D may include at least one user device 102, at least one behavioral fingerprint 110, at least one server device 112, at least one event 706, at least one utilization indicator 708, at least one environmental parameter 710, or at least one event analysis 712. Each of schematic diagrams 700B-700D may include alternative or additional depictions, which may relate to environmentally-responsive behavioral fingerprinting, as described herein. In addition to or in alternative to description herein below with specific reference to FIGS. 7B-7D, illustrated aspects of schematic diagrams 700B-700D may be relevant to example description with reference to FIG. 8A-8D, 9A-9D, or 10A-10B. However, claimed subject matter is not limited to any particular described embodiments, implementations, examples, etc.

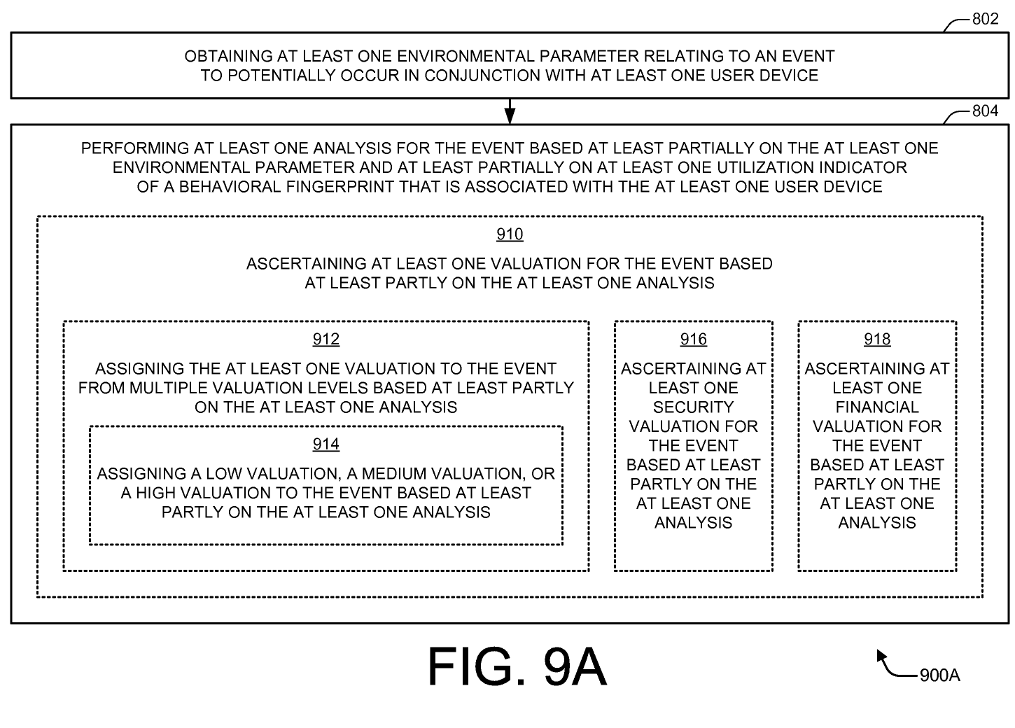

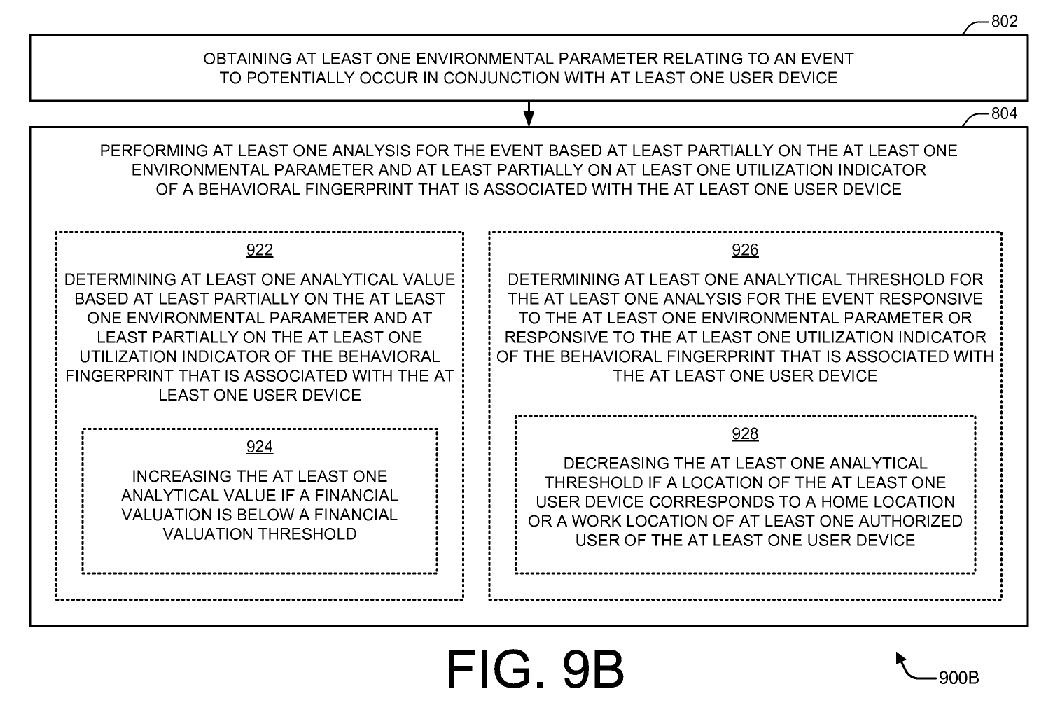

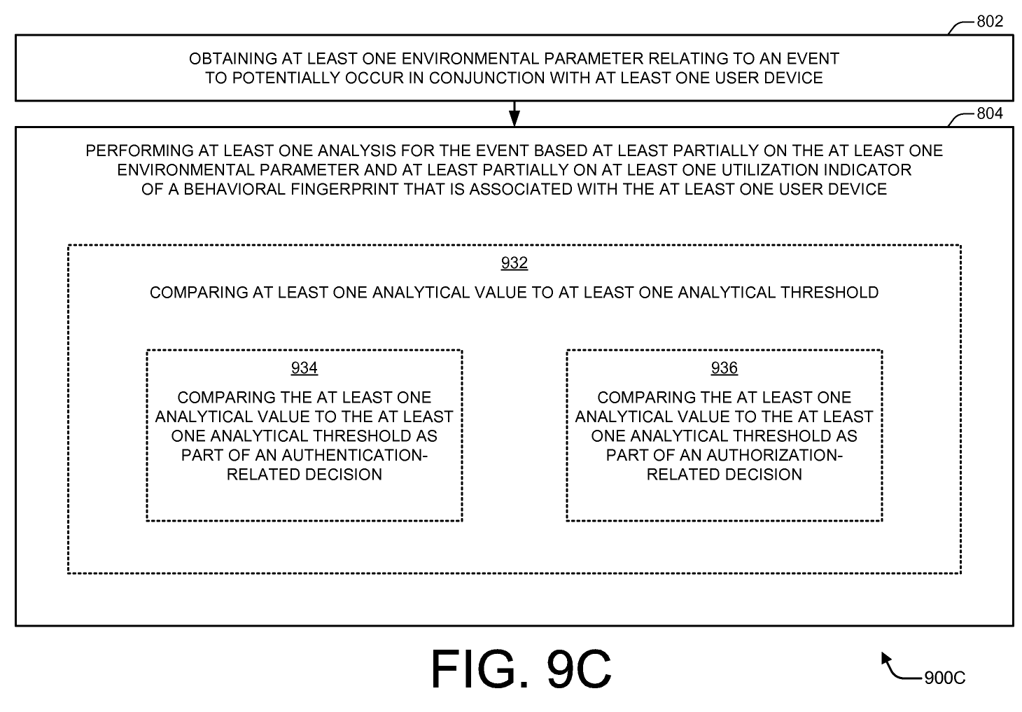

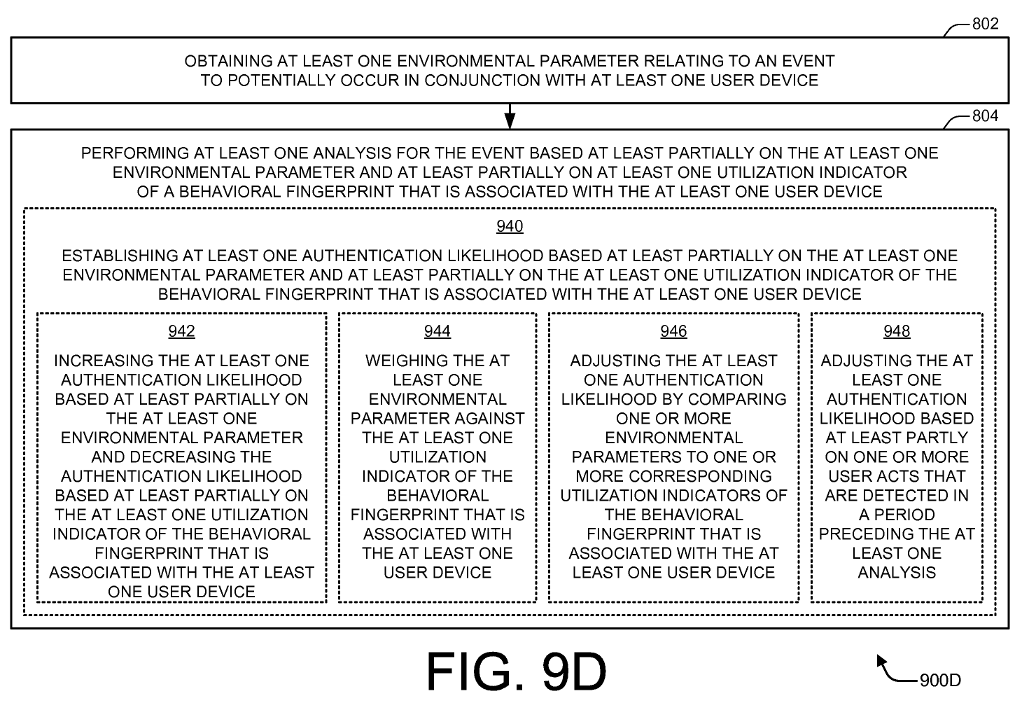

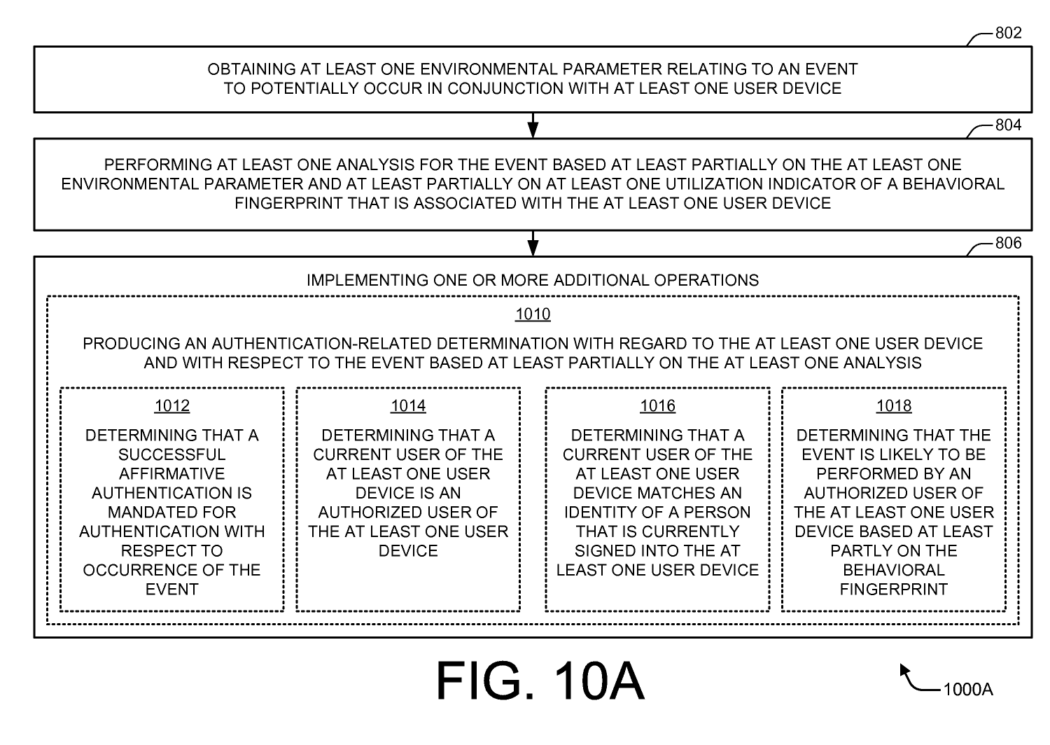

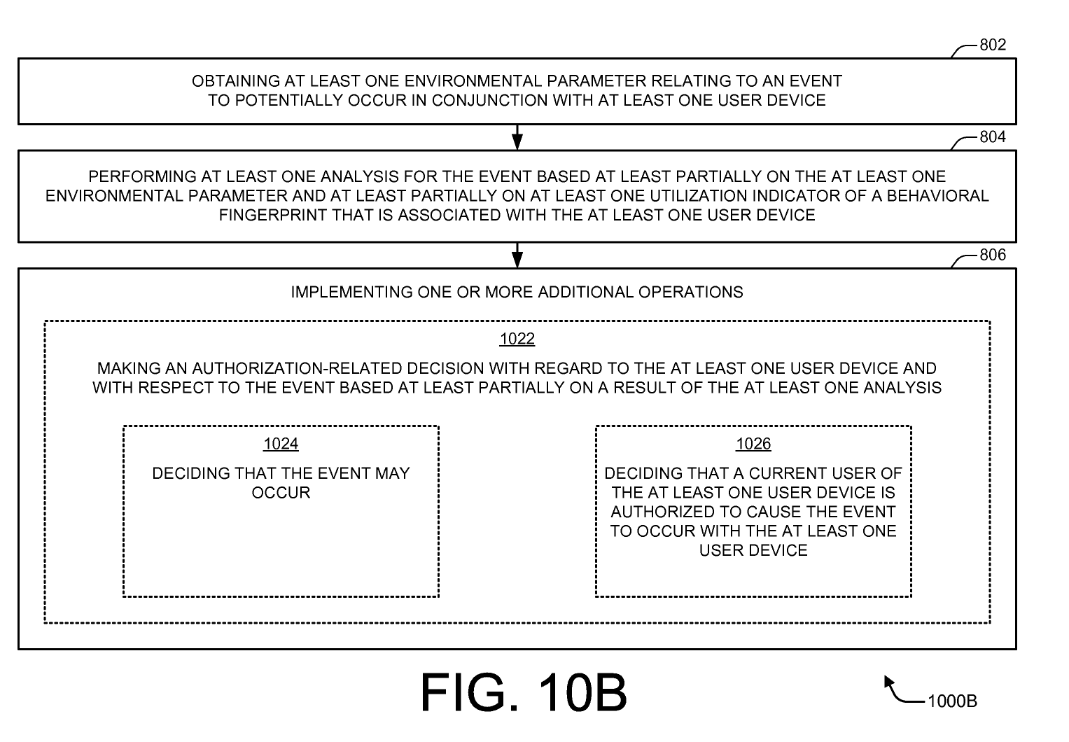

As shown in FIG. 7B, by way of example but not limitation, schematic diagram 700B may include at least one user device 102, at least one behavioral fingerprint 110, at least one server device 112, at least one event 706, at least one utilization indicator 708, at least one environmental parameter 710, or at least one event analysis 712. For certain example embodiments, an event 706 may comprise or include a happening, an occurrence, an action, an accomplishment, a purchase, an accessing, an unlocking, a communication, or a combination thereof, etc. that is effectuated or facilitated at least partially using or with or via at least one user device 102. For certain example embodiments, a behavioral fingerprint 110 may include one or more utilization indicators 708. For certain example implementations, at least one utilization indicator 708 may include or comprise at least one indicator of any of indicators 302-324 (e.g., of FIG. 3). However, claimed subject matter is not limited to any particular described embodiments, implementations, examples, etc. Additional or alternative description that may be relevant to schematic diagram 700B is provided herein below with particular reference to one or more of any of FIGS. 8A-8D, FIGS. 9A-9D, or FIGS. 10A-10B.

As shown in FIG. 7C, by way of example but not limitation, schematic diagram 700C may include at least one user device 102, at least one user 104, at least one behavioral fingerprint 110, at least one server device 112, at least one event 706, at least one utilization indicator 708, at least one environmental parameter 710, at least one event analysis 712, at least one social network 714, at least one cloud 716, or at least one other device 718. More specifically, for certain example embodiments, schematic diagram 700C may include: a user device 102 that may correspond to a user 104, which user may include or comprise an authorized user or an unauthorized user; a server device 112, which may operate within or as part of a cloud 716; an event analysis 712, which may analyze an event 706 that is to potentially occur; or an environmental parameter 710, which may relate to an event 706 or serve as at least one input for an event analysis 712. For certain example implementations, a cloud 716 may include at least a portion of a server device, one or more server devices, a provider or utilizer of a cloud service, a provider or utilizer of cloud computing, a combination thereof, or so forth. However, claimed subject matter is not limited to any particular described embodiments, implementations, examples, etc.

For certain example embodiments, a server device 112 may be operated by or for a social network 714 (or other third party service provider). A social network 714 may include, by way of example but not imitation, a service, a physical network, a communication layer of a network, an internet location, a website, a computing infrastructure, one or more servers, an application, an interface, cloud computing, or a combination thereof, etc. that enables or facilitates interaction (e.g., via text, images, audio, video, or a combination thereof, etc.) between or among two or more members of a social network. The term “social” in “social network” should not be interpreted to exclude networks designed or intended for professional or specific purposes. Examples of social networks may include, but are not limited to, Facebook, Google+, Twitter, LinkedIn, Myspace, Pinterest, Classmates[dot]com, Flickr, Foursquare, Friendster, LiveJournal, Meetup, Netlog, Orkut, Sina Weibo, Ozone, Habbo, Instagram, or so forth. However, claimed subject matter is not limited to any particular described embodiments, implementations, examples, etc.

For certain example embodiments, an other device 718 may be operated or owned by a user 104 of a user device 102, may be operated or owned by a service provider, may be operated or owned by a social network 714, may be operated or owned by a third party, may be operated or owned by a proprietor of an establishment, may be operated or owned by an entity affiliated with a server device 112, may be operated by one of the above and owned by another, or so forth. For certain example implementations, other device 718 may be communicatively coupled to a user device 102, a server device 112, a combination thereof, or so forth. By way of example but not limitation, other device 718: may be integrated with a user device 102, may be physically connected to a user device 102, may be wirelessly coupled to a user device 102, may be coupled by wire to a user device 102, may be coupled by wire or wirelessly to a server device 112, some combination thereof, or so forth. Other device 718 may additionally or alternatively be capable of bidirectional or unidirectional communication with multiple servers 112 (e.g., of a cloud computing environment 716 or via one or more channels 108 (e.g., of FIGS. 1 and 2A), which channel(s) 108 may include at least part of at least one network, such as an internet). Other device 718 may include or comprise, by way of example but not limitation, a point-of-sale (POS) terminal, such as a register; an attachment augmenting a POS terminal; an attachment to a user device 102; a device that accepts credit, debit, or other payment cards and is coupled to a user device 102 or a POS terminal; a device that accepts or generates sensor readings and forwards them to a server 112; a device that collects, determines, or forwards environmental parameter data; a device that forwards other data collected or produced at a user device 102 to a server 112; a combination thereof; or so forth. Data (e.g., relating to behavioral fingerprinting, social networking, utilization information, environmental parameters, event analysis, or a combination thereof, etc.) may be collected at or by other device 718 or funneled through other device 718 between or among at least one user device 102 or one or more server devices 112. However, claimed subject matter is not limited to any particular described embodiments, implementations, examples, etc. Additional or alternative description that may be relevant to schematic diagram 700C is provided herein below with particular reference to one or more of any of FIGS. 8A-8D, FIGS. 9A-9D, or FIGS. 10A-10B.

As shown in FIG. 7D, by way of example but not limitation, schematic diagram 700D may include at least one user device 102, at least one behavioral fingerprint 110, at least one server device 112, at least one event 706, at least one utilization indicator 708, at least one environmental parameter 710, at least one event analysis 712, at least one transaction value 720, at least one location 722, at least one security risk parameter 724, at least one valuation 726, at least one analytical value 728, at least one analytical threshold 730, or at least one authentication likelihood 732. However, claimed subject matter is not limited to any particular described embodiments, implementations, examples, etc. Additional or alternative description that may be relevant to schematic diagram 700D is provided herein below with particular reference to one or more of any of FIGS. 8A-8D, FIGS. 9A-9D, or FIGS. 10A-10B.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

FIG. 8A is a flow diagram 800A illustrating an example method for at least one device with regard to environmentally-responsive behavioral fingerprinting in accordance with certain example embodiments. As illustrated, flow diagram 800A may include any of operations 802-804. Although operations 802-804 are shown or described in a particular order, it should be understood that methods may be performed in alternative manners without departing from claimed subject matter, including, but not limited to, with a different order or number of operations or with a different relationship between or among operations. Also, at least some operation(s) of flow diagram 800A may be performed so as to be fully or partially overlapping with other operation(s). For certain example embodiments, one or more operations of flow diagram 800A may be performed by at least one server device (e.g., a server device 112). Alternatively, one or more operations of flow diagram 800A may be performed by at least one user device (e.g., a user device 102).

For certain example embodiments, a method for environmentally-responsive behavioral fingerprinting, which method may be at least partially implemented using hardware (e.g., circuitry, at least one processor, processor-accessible memory, or a combination thereof, etc.) such as that of a server device, may include an operation 802 or an operation 804. An operation 802 may be directed at least partially to obtaining at least one environmental parameter relating to an event to potentially occur in conjunction with at least one user device. For certain example implementations, at least one device may obtain (e.g., acquire, ascertain, determine, deduce, receive such as from an electromagnetic communication, retrieve such as from memory, conclude from one or more factors, or a combination thereof, etc.) at least one environmental parameter 710 (e.g., a value, a parameter, an indication of surroundings, a description, a financial valuation, a security level, a location, proximate other user devices, or a combination thereof, etc.) relating to (e.g., associated with, corresponding to, descriptive of, indicative of, pertaining to, or a combination thereof, etc.) an event 706 (e.g., a happening, an action, an occurrence, an exchange, a purchase, an accessing, an unlocking, a meeting, a usage, a transfer, a communication, or a combination thereof, etc.) to potentially occur (e.g., to possibly happen, to conditionally transpire, to occur upon approval, to develop if permitted, to involve an analysis, to continue if not blocked, or a combination thereof, etc.) in conjunction with (e.g., along with, as requested by, as facilitated by, via, at least partially using, involving, or a combination thereof, etc.) at least one user device 102. By way of example but not limitation, a server may obtain at least one environmental parameter relating to an event to potentially occur in conjunction with at least one user device (e.g., a Google server may receive from an Android Nexus smartphone a dollar valuation of a purchase to be made via Google Wallet using the Android Nexus smartphone). However, claimed subject matter is not limited to any particular described embodiments, implementations, examples, etc.

For certain example embodiments, an operation 804 may be directed at least partially to performing at least one analysis for the event based at least partially on the at least one environmental parameter and at least partially on at least one utilization indicator of a behavioral fingerprint that is associated with the at least one user device. For certain example implementations, at least one device may perform at least one analysis 712 (e.g., consideration of factors, examination, investigation, weighing of inputs, decision, application of a probabilistic mechanism, determination of propriety, or a combination thereof, etc.) for event 706 based at least partially on (e.g., using, considering, being impacted by, factoring in, accepting as input, or a combination thereof, etc.) at least one environmental parameter 710 and at least partially on at least one utilization indicator 708 (e.g., a label, a categorization, a code, a tag, an assignment, one or more words, a description, an association, an act, a prediction, or a combination thereof, etc. that represents, embodies, describes, suggests, or a combination thereof, etc. at least one utilization (e.g., accessing, using, interacting with, carrying, moving from place to place, providing input to, receiving output from, communicating with, running apps on, requesting or completing or effecting transactions via, directing operation of, or a combination thereof, etc.) of a user device) of a behavioral fingerprint 110 that is associated with (e.g., linked to, affecting the capabilities of, at least partially controlling, having indicator(s) that are capable of being modified responsive to use of, stored at, associated with an account corresponding to, associated with an authorized user of, or a combination thereof, etc.) at least one user device 102. By way of example but not limitation, a server may perform at least one analysis for the event based at least partially on the at least one environmental parameter and at least partially on at least one utilization indicator of a behavioral fingerprint that is associated with the at least one user device (e.g., a Google server may investigate the appropriateness of permitting an Android Nexus phone to be used to purchase a new men's suit for $3,000 in light of a behavioral fingerprint indicator that an owner thereof is female and has only purchased women's clothing for amounts totaling less than $500 over the last two years). However, claimed subject matter is not limited to any particular described embodiments, implementations, examples, etc.

FIGS. 8B-8D depict example additions or alternatives for a flow diagram of FIG. 8A in accordance with certain example embodiments. As illustrated, flow diagrams of FIGS. 8B-8D may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently). Also, at least some operation(s) of flow diagrams of FIGS. 8B-8D may be performed so as to be fully or partially overlapping with other operation(s). For certain example embodiments, one or more operations of flow diagrams 800B-800D (of FIGS. 8B-8D) may be performed by at least one server device (e.g., a server device 112). Alternatively, one or more operations of flow diagrams 800B-800D may be performed by at least one user device (e.g., a user device 102).

FIG. 8B illustrates a flow diagram 800B having example operations 810, 812, 814, or 816. For certain example embodiments, an operation 810 may be directed at least partially to wherein the obtaining at least one environmental parameter relating to an event to potentially occur in conjunction with at least one user device (of operation 802) includes obtaining at least one value of a transaction to potentially occur in conjunction with the at least one user device. For certain example implementations, at least one device may obtain at least one value 720 (e.g., a monetary value, a number of items value, a value representing a length in time or occurrences of an obligation, or a combination thereof, etc.) of a transaction (e.g., a purchase, a lease, a subscription, a rental, an order, a license, an agreement for performance, or a combination thereof, etc.) to potentially occur in conjunction with at least one user device 102. By way of example but not limitation, a server may obtain at least one value of a transaction to potentially occur in conjunction with the at least one user device (e.g., a PayPal server may receive from a PayPal app executing on a tablet a length of a membership for a gym that may be joined if a gym membership contract is electronically signed or legally executed or if funds for the gym membership contract are transferred). However, claimed subject matter is not limited to any particular described embodiments, implementations, examples, etc.

For certain example embodiments, an operation 812 may be directed at least partially to wherein the obtaining at least one value of a transaction to potentially occur in conjunction with the at least one user device (of operation 810) includes obtaining at least one cost of an item potentially being purchased in conjunction with the at least one user device. For certain example implementations, at least one device may obtain at least one cost (e.g., a price, a sales price, a suggested retail price, a list price, a total price, a processing and handling fee, a shipping fee, an upfront fee, a recurring fee, or a combination thereof, etc.) of an item (e.g., a physical good such as coffee maker, a virtual good such as a movie or a game feature, a physical service such as a massage, a virtual service such as remote computer maintenance, or a combination thereof, etc.) potentially being purchased (e.g., bought, acquired for consideration, ordered, or a combination thereof, etc.) in conjunction with at least one user device 102. By way of example but not limitation, a server may obtain at least one cost of an item potentially being purchased in conjunction with the at least one user device (e.g., an American Express server may receive via a point of sale terminal a price for a boat that a customer who is using a mobile smartphone as identification wants to purchase). However, claimed subject matter is not limited to any particular described embodiments, implementations, examples, etc.

For certain example embodiments, an operation 814 may be directed at least partially to wherein the obtaining at least one environmental parameter relating to an event to potentially occur in conjunction with at least one user device (of operation 802) includes obtaining at least one location relating to the event to potentially occur in conjunction with the at least one user device. For certain example implementations, at least one device may obtain at least one location 722 (e.g., an address, a store name, a neighborhood, a city, a place name such as home or a friend's house or a school, a shopping center, one or more satellite positioning service (SPS) coordinates such as GPS, cardinal direction map coordinates, or a combination thereof, etc.) relating to an event 706 to potentially occur in conjunction with at least one user device 102. By way of example but not limitation, a server may obtain at least one location relating to the event to potentially occur in conjunction with the at least one user device (e.g., an Apple server may ascertain a location where a concert is to occur or where concert tickets are to be delivered if a MacBook is being used to order or pay for the concert tickets, such as if an Apple Passbook feature is being utilized). However, claimed subject matter is not limited to any particular described embodiments, implementations, examples, etc.

For certain example embodiments, an operation 816 may be directed at least partially to wherein the obtaining at least one location relating to the event to potentially occur in conjunction with the at least one user device (of operation 814) includes determining that the at least one location relating to the event to potentially occur in conjunction with the at least one user device corresponds to a home of an authorized user of the at least one user device. For certain example implementations, at least one device may determine (e.g., ascertain from information, deduce from data, conclude, or a combination thereof, etc.) that at least one location 722 relating to an event 706 to potentially occur in conjunction with at least one user device 102 corresponds to a home (e.g., an address, a geographic area, SPS coordinates along with a distance range, an abode, a position a person is usually present at during the night or away from work, or a combination thereof, etc.) of an authorized user (e.g., a user 104 that is authorized to use a given user device 102 to at least some extent, a user 104 that is associated with a behavioral fingerprint 110 corresponding to a given user device 102, an owner of a given user device 102, or a combination thereof, etc.) of at least one user device 102. By way of example but not limitation, a server may determine that the at least one location relating to the event to potentially occur in conjunction with the at least one user device corresponds to a home of an authorized user of the at least one user device (e.g., a Google server may determine from a detectable Wi-Fi network that a Samsung Galaxy Tab Android-based tablet is being used to attempt to access a Gmail account from a home of an account holder of the Gmail account). However, claimed subject matter is not limited to any particular described embodiments, implementations, examples, etc.

FIG. 8C illustrates a flow diagram 800C having example operations 820, 822, 824, 826, or 828. For certain example embodiments, an operation 820 may be directed at least partially to wherein the obtaining at least one environmental parameter relating to an event to potentially occur in conjunction with at least one user device (of operation 802) includes obtaining at least one security risk parameter relating to the event to potentially occur in conjunction with the at least one user device. For certain example implementations, at least one device may obtain at least one security risk parameter 724 (e.g., a description, a code, a term, a level, a value, alphanumeric characters, a color, or a combination thereof, etc.) relating to an event 706 to potentially occur in conjunction with at least one user device 102. By way of example but not limitation, a server may obtain at least one security risk parameter relating to the event to potentially occur in conjunction with the at least one user device (e.g., a Google Wallet server may receive from a Google Shopping server a code indicative of how much harm might befall an underage Google Wallet account holder if a purchase of a case of vodka is consummated with a Google Nexus Android smartphone). However, claimed subject matter is not limited to any particular described embodiments, implementations, examples, etc.

For certain example embodiments, an operation 822 may be directed at least partially to wherein the obtaining at least one security risk parameter relating to the event to potentially occur in conjunction with the at least one user device (of operation 820) includes obtaining at least one parameter indicative of a security level relating to the event to potentially occur in conjunction with the at least one user device. For certain example implementations, at least one device may obtain at least one parameter 724 indicative of a security level (e.g., a number, a color, a ranked term, or a combination thereof, etc.) relating to an event 706 to potentially occur in conjunction with at least one user device 102. By way of example but not limitation, a server may obtain at least one parameter indicative of a security level relating to the event to potentially occur in conjunction with the at least one user device (e.g., a Verizon server may receive from a third party source or may determine from ascertainable evidence, such as map annotations, that a request to navigate to a particular address using a Verizon Motorola Droid corresponds to a red or 8/10 security level). However, claimed subject matter is not limited to any particular described embodiments, implementations, examples, etc.

For certain example embodiments, an operation 824 may be directed at least partially to wherein the obtaining at least one security risk parameter relating to the event to potentially occur in conjunction with the at least one user device (of operation 820) includes obtaining at least one parameter indicative of funds that may be extended in relation to the event to potentially occur in conjunction with the at least one user device. For certain example implementations, at least one device may obtain at least one parameter 724 indicative of funds (e.g., money, credit, cash, gift card balance, bank account balance, numeral value, numeric range, or a combination thereof, etc.) that may be extended (e.g., spent, incurred, placed on-hold, deducted from an account, earmarked as pending, used, placed in jeopardy, or a combination thereof, etc.) in relation to an event 706 to potentially occur in conjunction with at least one user device 102. By way of example but not limitation, a server may obtain at least one parameter indicative of funds that may be extended in relation to the event to potentially occur in conjunction with the at least one user device (e.g., a Square server may receive from a Square payment systems device coupled to an Apple iPhone a price to sell three oriental rugs or a Visa server may receive from a BlackBerry smartphone the price to buy three oriental rugs). However, claimed subject matter is not limited to any particular described embodiments, implementations, examples, etc.

For certain example embodiments, an operation 826 may be directed at least partially to wherein the obtaining at least one security risk parameter relating to the event to potentially occur in conjunction with the at least one user device (of operation 820) includes obtaining at least one parameter indicative of whether personal confidential information may be exposed in relation to the event to potentially occur in conjunction with the at least one user device. For certain example implementations, at least one device may obtain at least one parameter 724 indicative of whether personal confidential information (e.g., a birthdate, a password, a username, a social security number, a bank account number, a credit card account number, a place of birth, an answer to a security question, or a combination thereof, etc.) may be exposed (e.g., transmitted to a nefarious destination, transmitted in plaintext, decrypted, provided to malware, stored unencrypted, surreptitiously accessed, displayed, accessed or made accessible to an app, or a combination thereof, etc.) in relation to an event 706 to potentially occur in conjunction with at least one user device 102. By way of example but not limitation, a server may obtain at least one parameter indicative of whether personal confidential information may be exposed in relation to the event to potentially occur in conjunction with the at least one user device (e.g., a Symantec Norton server may ascertain an indication, such as a probability, that a person's password will be transmitted to an unintended destination or to an intended destination in unencrypted plaintext if a result of a user clicking a link on a tablet computer is permitted to proceed without intervention by a Norton client program on the tablet computer). However, claimed subject matter is not limited to any particular described embodiments, implementations, examples, etc.

For certain example embodiments, an operation 828 may be directed at least partially to wherein the obtaining at least one security risk parameter relating to the event to potentially occur in conjunction with the at least one user device (of operation 820) includes obtaining at least one parameter indicative of whether communications may be accessible as a consequence of the event to potentially occur in conjunction with the at least one user device. For certain example implementations, at least one device may obtain at least one parameter 724 indicative of whether communications (e.g., emails, text messages, social network messages, a social network stream or wall, voice mails, a phone capability, an email feature, a social network application, a text messaging application or a combination thereof, etc.) may be accessible (e.g., viewable, capable of being listened to, capable of being read, launched, brought to a foreground of a desktop or screen, capable of being used, capable of being edited or deleted, or a combination thereof, etc.) as a consequence of (e.g., as a result of, as being caused by, as failing to be stopped by, after an occurrence of, after the door is opened by, or a combination thereof, etc.) an event 706 to potentially occur in conjunction with at least one user device 102. By way of example but not limitation, a server may obtain at least one parameter indicative of whether communications may be accessible as a consequence of the event to potentially occur in conjunction with the at least one user device (e.g., a Microsoft server may process an indication that emails are to be viewed on an HTC smartphone running Windows Phone 8 if a request to view an Outlook Inbox is approved or is not prevented from progressing). However, claimed subject matter is not limited to any particular described embodiments, implementations, examples, etc.

FIG. 8D illustrates a flow diagram 800D having example operations 832, 834, 836, 838, or 840. For certain example embodiments, an operation 832 may be directed at least partially to wherein the obtaining at least one environmental parameter relating to an event to potentially occur in conjunction with at least one user device (of operation 802) includes obtaining the at least one environmental parameter relating to the event, with the event requested by a current user of the at least one user device, to potentially occur in conjunction with the at least one user device. For certain example implementations, at least one device may obtain at least one environmental parameter 710 relating to an event 706, with event 706 requested by a current user (e.g., a user 104 that is directing operation of a user device at a time of a request, a user 104 that is manipulating user interface controls of a user device contemporaneously with a time of an analysis, a person that is holding a user device to activate something or perform an action, or a combination thereof, etc.) of at least one user device 102, to potentially occur in conjunction with at least one user device 102. By way of example but not limitation, a server may obtain the at least one environmental parameter relating to the event, with the event requested by a current user of the at least one user device, to potentially occur in conjunction with the at least one user device (e.g., an at&t server may receive a current location of a mobile phone that is transmitting a request by or from an operating user thereof to make plan changes to an at&t data plan to which the mobile phone is affiliated). However, claimed subject matter is not limited to any particular described embodiments, implementations, examples, etc.

For certain example embodiments, an operation 834 may be directed at least partially to wherein the obtaining at least one environmental parameter relating to an event to potentially occur in conjunction with at least one user device (of operation 802) includes obtaining the at least one environmental parameter relating to the event, with the event requested by at least a portion of the at least one user device, to potentially occur in conjunction with the at least one user device. For certain example implementations, at least one device may obtain at least one environmental parameter 710 relating to an event 706, with event 706 requested by at least a portion (e.g., an application, an operating system (OS) function, an original equipment manufacturer (OEM)-installed feature, a wireless service provider skin capability, or a combination thereof, etc.) of at least one user device 102, to potentially occur in conjunction with at least one user device 102. By way of example but not limitation, a server may obtain the at least one environmental parameter relating to the event, with the event requested by at least a portion of the at least one user device, to potentially occur in conjunction with the at least one user device (e.g., an ADT Home Security System server may determine a time of day when an automated, proximity-based request to unlock a homeowner's door by an application installed on a smartphone is received from the smartphone). However, claimed subject matter is not limited to any particular described embodiments, implementations, examples, etc.

For certain example embodiments, an operation 836 may be directed at least partially to wherein the obtaining at least one environmental parameter relating to an event to potentially occur in conjunction with at least one user device (of operation 802) includes obtaining the at least one environmental parameter relating to the event to occur in conjunction with the at least one user device as conditioned on an authentication of a current user of the at least one user device. For certain example implementations, at least one device may obtain at least one environmental parameter 710 relating to an event 706 to occur in conjunction with at least one user device 102 as conditioned on (e.g., made at least partially dependent on, advancement being responsive to, approval affected by, or a combination thereof, etc.) an authentication (e.g., a determination that a user is at least likely who the user purports to be, an ascertainment that a current user is at least likely an authorized user of a user device, a decision that a current user is at least likely to be a person that is currently signed into a user device, or a combination thereof, etc.) of a current user (e.g., a user 104 that is directing operation of a user device at a time of a request for an event to occur, a user 104 that is manipulating user interface controls of a user device contemporaneously with a time of an analysis, a person that is holding a user device to activate something or perform an action, or a combination thereof, etc.) of at least one user device 102. By way of example but not limitation, a server may obtain the at least one environmental parameter relating to the event to occur in conjunction with the at least one user device as conditioned on an authentication of a current user of the at least one user device (e.g., a Google Wallet server may obtain a time since a most-recent affirmative authentication was performed in relation to a requested purchase that is predicated on Google Wallet determining that a current user of an HTC Android smartphone is an account holder for a Google Wallet account). However, claimed subject matter is not limited to any particular described embodiments, implementations, examples, etc.

For certain example embodiments, an operation 838 may be directed at least partially to wherein the obtaining at least one environmental parameter relating to an event to potentially occur in conjunction with at least one user device (of operation 802) includes obtaining the at least one environmental parameter relating to the event to occur in conjunction with the at least one user device as conditioned on an authorization for the event to be approved to unfold. For certain example implementations, at least one device may obtain at least one environmental parameter 710 relating to an event 706 to occur in conjunction with at least one user device 102 as conditioned on (e.g., made at least partially dependent on, advancement being responsive to, approval affected by, or a combination thereof, etc.) an authorization (e.g., permission, agreement, approval, sanction, or a combination thereof, etc.) for event 706 to be approved to unfold (e.g., continue, progress, be completed, be concluded, happen, be consummated, or a combination thereof, etc.). By way of example but not limitation, a server may obtain the at least one environmental parameter relating to the event to occur in conjunction with the at least one user device as conditioned on an authorization for the event to be approved to unfold (e.g., a McAfee server may retrieve a listing of websites visited during a previous hour in relation to a request to view banking information via the web with an Apple iPad, with the banking information via the web not being displayed on the Apple iPad until the McAfee server grants permission). However, claimed subject matter is not limited to any particular described embodiments, implementations, examples, etc.

For certain example embodiments, an operation 840 may be directed at least partially to wherein the obtaining at least one environmental parameter relating to an event to potentially occur in conjunction with at least one user device (of operation 802) includes obtaining the at least one environmental parameter relating to the event to occur in conjunction with the at least one user device as conditioned on an absence of an attempt to block occurrence of the event. For certain example implementations, at least one device may obtain at least one environmental parameter 710 relating to an event 706 to occur in conjunction with at least one user device 102 as conditioned (e.g., made at least partially dependent on, advancement being responsive to, approval affected by, or a combination thereof, etc.) on an absence of an attempt (e.g., lacking transmission of a signal, failure to issue a cessation instruction, not sending a negatory indication, or a combination thereof, etc.) to block occurrence (e.g., stop conclusion, prevent continuance, end progression, keep from happening, or a combination thereof, etc.) of event 706. By way of example but not limitation, a server may obtain the at least one environmental parameter relating to the event to occur in conjunction with the at least one user device as conditioned on an absence of an attempt to block occurrence of the event (e.g., a server may obtain an age appropriateness rating for a URL that is requested to be accessed by a user of a phablet with a web page thereof to be displayed by the phablet unless the server sends a signal to the phablet to prevent the display). However, claimed subject matter is not limited to any particular described embodiments, implementations, examples, etc.

FIGS. 9A-9D depict example additions or alternatives for a flow diagram of FIG. 8A in accordance with certain example embodiments. As illustrated, flow diagrams of FIGS. 9A-9D may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently). Also, at least some operation(s) of flow diagrams of FIGS. 9A-9D may be performed so as to be fully or partially overlapping with other operation(s). For certain example embodiments, one or more operations of flow diagrams 900A-900D (of FIGS. 9A-9D) may be performed by at least one server device (e.g., a server device 112). Alternatively, one or more operations of flow diagrams 900A-900D may be performed by at least one user device (e.g., a user device 102).

FIG. 9A illustrates a flow diagram 900A having example operations 910, 912, 914, 916, or 918. For certain example embodiments, an operation 910 may be directed at least partially to wherein the performing at least one analysis for the event based at least partially on the at least one environmental parameter and at least partially on at least one utilization indicator of a behavioral fingerprint that is associated with the at least one user device (of operation 804) includes ascertaining at least one valuation for the event based at least partly on the at least one analysis. For certain example implementations, at least one device may ascertain (e.g., determine, calculate, retrieve, formulate, or a combination thereof, etc.) at least one valuation 726 (e.g., degree of importance; measure of risk; potential personal impact, potential professional impact; or a combination thereof; etc.) for an event 706 based at least partly on at least one analysis 712. By way of example but not limitation, a server may ascertain at least one valuation for the event based at least partly on the at least one analysis (e.g., a Verizon server may calculate a representation of an amount of potential harm or a likelihood of potential harm that may befall an authorized user if a vehicle is started automatically as a consequence of a proximity between a Verizon Droid smartphone and a vehicle at a given time while the authorized user is scheduled to be in the middle of a meeting at the given time according to a calendar associated with the authorized user). However, claimed subject matter is not limited to any particular described embodiments, implementations, examples, etc.

For certain example embodiments, an operation 912 may be directed at least partially to wherein the ascertaining at least one valuation for the event based at least partly on the at least one analysis (of operation 910) includes assigning the at least one valuation to the event from multiple valuation levels based at least partly on the at least one analysis. For certain example implementations, at least one device may assign at least one valuation 726 to an event 706 from multiple valuation levels (e.g., multiple hierarchical levels, multiple mutually-exclusive levels, multiple overlapping levels, multiple calculated levels, multiple predetermined levels, multiple levels having ranges, or a combination thereof, etc.) based at least partly on at least one analysis 712. By way of example but not limitation, a server may assign the at least one valuation to the event from multiple valuation levels based at least partly on the at least one analysis (e.g., an Apple server may assign a request to launch or access a communication program with an iPad Mini a valuation level selected from a group including financial risk, personal information risk, existing messages risk, outgoing messages risk, or systems settings risk). However, claimed subject matter is not limited to any particular described embodiments, implementations, examples, etc.

For certain example embodiments, an operation 914 may be directed at least partially to wherein the assigning the at least one valuation to the event from multiple valuation levels based at least partly on the at least one analysis (of operation 912) includes assigning a low valuation, a medium valuation, or a high valuation to the event based at least partly on the at least one analysis. For certain example implementations, at least one device may assign a low valuation, a medium valuation, or a high valuation (e.g., one of three ranked levels, one of three financial risk levels, one of three device security levels, or a combination thereof, etc.) to an event 706 based at least partly on at least one analysis 712. By way of example but not limitation, a server may assign a low valuation, a medium valuation, or a high valuation to the event based at least partly on the at least one analysis (e.g., a PayPal server may assign a low risk/cost valuation to an intended purchase at a Starbucks store using a Samsung Galaxy smartphone if the purchase is under $10 and the Samsung Galaxy smartphone has been used previously at the same Starbucks store). However, claimed subject matter is not limited to any particular described embodiments, implementations, examples, etc.

For certain example embodiments, an operation 916 may be directed at least partially to wherein the ascertaining at least one valuation for the event based at least partly on the at least one analysis (of operation 910) includes ascertaining at least one security valuation for the event based at least partly on the at least one analysis. For certain example implementations, at least one device may ascertain at least one security valuation (e.g., a security-related label, a numerical value, an indication of an extent of a security risk, or a combination thereof, etc.) for an event 706 based at least partly on at least one analysis 712. By way of example but not limitation, a server may ascertain at least one security valuation for the event based at least partly on the at least one analysis (e.g., an at&t server may determine that installing a program asserting to be from a banking institution onto a Windows Phone 8 smartphone is an event that is to be associated with a high security assessment). However, claimed subject matter is not limited to any particular described embodiments, implementations, examples, etc.

For certain example embodiments, an operation 918 may be directed at least partially to wherein the ascertaining at least one valuation for the event based at least partly on the at least one analysis (of operation 910) includes ascertaining at least one financial valuation for the event based at least partly on the at least one analysis. For certain example implementations, at least one device may ascertain at least one financial valuation (e.g., an amount of money put a risk, an estimated total cost of a transaction, a price of an item, an extent to which financial information is put at risk, or a combination thereof, etc.) for an event 706 based at least partly on at least one analysis 712. By way of example but not limitation, a server may ascertain at least one financial valuation for the event based at least partly on the at least one analysis (e.g., an American Express server that is in communication with an American Express application on an iPhone may determine that approving a given transaction request would result in a $759 charge). However, claimed subject matter is not limited to any particular described embodiments, implementations, examples, etc.

FIG. 9B illustrates a flow diagram 900B having example operations 922, 924, 926, or 928. For certain example embodiments, an operation 922 may be directed at least partially to wherein the performing at least one analysis for the event based at least partially on the at least one environmental parameter and at least partially on at least one utilization indicator of a behavioral fingerprint that is associated with the at least one user device (of operation 804) includes determining at least one analytical value based at least partially on the at least one environmental parameter and at least partially on the at least one utilization indicator of the behavioral fingerprint that is associated with the at least one user device. For certain example implementations, at least one device may determine at least one analytical value 728 (e.g., a numerical value, a code, a result of a calculation, a coefficient, a likelihood indication, a probabilistic output, a machine learning product, or a combination thereof, etc.) based at least partially on at least one environmental parameter 710 and at least partially on at least one utilization indicator 708 of a behavioral fingerprint 110 that is associated with at least one user device 102. By way of example but not limitation, a server may determine at least one analytical value based at least partially on the at least one environmental parameter and at least partially on the at least one utilization indicator of the behavioral fingerprint that is associated with the at least one user device (e.g., an Apple server may determine a code representing a likelihood that a user associated with a behavioral fingerprint is attempting to acquire with an iPad an app from Apple's app store given a category of the app and categories of previous apps that have been installed on the iPad by the associated user). However, claimed subject matter is not limited to any particular described embodiments, implementations, examples, etc.

For certain example embodiments, an operation 924 may be directed at least partially to wherein the determining at least one analytical value based at least partially on the at least one environmental parameter and at least partially on the at least one utilization indicator of the behavioral fingerprint that is associated with the at least one user device (of operation 922) includes increasing the at least one analytical value if a financial valuation is below a financial valuation threshold. For certain example implementations, at least one device may increase at least one analytical value 728 (e.g., a numerical value, a code, a result of a calculation, a coefficient, a likelihood indication, a numerical range, a confidence interval, a probabilistic output, a machine learning product, or a combination thereof, etc.) if a financial valuation (e.g., an amount of money put a risk, an estimated total cost of a transaction, a price of an item, an extent to which financial information is put at risk, or a combination thereof, etc.) is below a financial valuation threshold (e.g., a level, a minimum or maximum, a point to measure against, or a combination thereof, etc.). By way of example but not limitation, a server may increase the at least one analytical value if a financial valuation is below a financial valuation threshold (e.g., a Bank of America server may increase a likelihood value that a request to use a debit card application on a smartphone is from an authorized requester if the dollar value for the requested debit card transaction is below $25). However, claimed subject matter is not limited to any particular described embodiments, implementations, examples, etc.

For certain example embodiments, an operation 926 may be directed at least partially to wherein the performing at least one analysis for the event based at least partially on the at least one environmental parameter and at least partially on at least one utilization indicator of a behavioral fingerprint that is associated with the at least one user device (of operation 804) includes determining at least one analytical threshold for the at least one analysis for the event responsive to the at least one environmental parameter or responsive to the at least one utilization indicator of the behavioral fingerprint that is associated with the at least one user device. For certain example implementations, at least one device may determine at least one analytical threshold 730 (e.g., a level, a minimum or maximum, a point to measure against, an amount to use in a comparison, a defined range, or a combination thereof, etc.) for at least one analysis 712 for an event 706 responsive to at least one environmental parameter 710 or responsive to at least one utilization indicator 708 of a behavioral fingerprint 110 that is associated with at least one user device 102. By way of example but not limitation, a server may determine at least one analytical threshold for the at least one analysis for the event responsive to the at least one environmental parameter or responsive to the at least one utilization indicator of the behavioral fingerprint that is associated with the at least one user device (e.g., a Starbucks server may determine a minimum level or a maximum level as a result of or for use with an analysis responsive to an item currently being ordered with a smartphone or responsive to which Starbucks a customer usually patronizes as indicated in a behavioral fingerprint). However, claimed subject matter is not limited to any particular described embodiments, implementations, examples, etc.

For certain example embodiments, an operation 928 may be directed at least partially to wherein the determining at least one analytical threshold for the at least one analysis for the event responsive to the at least one environmental parameter or responsive to the at least one utilization indicator of the behavioral fingerprint that is associated with the at least one user device (of operation 926) includes decreasing the at least one analytical threshold if a location of the at least one user device corresponds to a home location or a work location of at least one authorized user of the at least one user device. For certain example implementations, at least one device may decrease at least one analytical threshold 730 (e.g., a level, a minimum or maximum, a point to measure against, an amount to use in a comparison, a defined range, or a combination thereof, etc.) if a location of at least one user device 102 corresponds to a home location or a work location of at least one authorized user (e.g., a user 104 that is authorized to use a given user device 102 to at least some extent, a user 104 that is associated with a behavioral fingerprint 110 corresponding to a given user device 102, an owner of a given user device 102, or a combination thereof, etc.) of at least one user device 102. By way of example but not limitation, a server may decrease the at least one analytical threshold if a location of the at least one user device corresponds to a home location or a work location of at least one authorized user of the at least one user device (e.g., a Chase server may decrease a threshold level for meeting an authentication requirement to use a credit card to place an order via a browser of a tablet computer if the tablet computer is located at the home or work of an authorized user of the tablet computer when the order is attempted to be placed). However, claimed subject matter is not limited to any particular described embodiments, implementations, examples, etc.

FIG. 9C illustrates a flow diagram 900C having example operations 932, 934, or 936. For certain example embodiments, an operation 932 may be directed at least partially to wherein the performing at least one analysis for the event based at least partially on the at least one environmental parameter and at least partially on at least one utilization indicator of a behavioral fingerprint that is associated with the at least one user device (of operation 804) includes comparing at least one analytical value to at least one analytical threshold. For certain example implementations, at least one device may compare (e.g., determine if one is larger or smaller, weigh one against another, determine a greatest size, ascertain if one fits within a range of another, consider relevant categories or nature of both, or a combination thereof, etc.) at least one analytical value 728 (e.g., a numerical value, a code, a result of a calculation, a coefficient, a likelihood indication, a probabilistic output, a machine learning product, or a combination thereof, etc.) to at least one analytical threshold 730 (e.g., a level, a minimum or maximum, a point to measure against, an amount to use in a comparison, a defined range, or a combination thereof, etc.). By way of example but not limitation, a server may compare at least one analytical value to at least one analytical threshold (e.g., a Lookout server that is in communication with a Lookout process on an LG smartphone that is attempting to download a game pack extension may compare a probability that an authorized user wants the download to occur to a probability threshold for permitting a downloading of executable code). However, claimed subject matter is not limited to any particular described embodiments, implementations, examples, etc.

For certain example embodiments, an operation 934 may be directed at least partially to wherein the comparing at least one analytical value to at least one analytical threshold (of operation 932) includes comparing the at least one analytical value to the at least one analytical threshold as part of an authentication-related determination. For certain example implementations, at least one device may compare at least one analytical value 728 (e.g., a numerical value, a code, a result of a calculation, a coefficient, a likelihood indication, a probabilistic output, a machine learning product, or a combination thereof, etc.) to at least one analytical threshold 730 (e.g., a level, a minimum or maximum, a point to measure against, an amount to use in a comparison, a defined range, or a combination thereof, etc.) as part of an authentication-related determination (e.g., a determination that a user is at least likely who the user purports to be, an ascertainment that a current user is at least likely an authorized user of a user device, a conclusion that a current user is at least likely to be a person that is currently signed into a user device, or a combination thereof, etc.). By way of example but not limitation, a server may compare the at least one analytical value to the at least one analytical threshold as part of an authentication-related determination (e.g., a Microsoft server may determine if a likelihood range, such as a normally-distributed predictive measure, that derives from a user's interactions with a Microsoft Surface tablet comports with a minimum range of certainty as part of a determination of whether a current user is to be considered an authorized user that is currently signed into the Surface tablet if the current user is requesting to perform a privileged action). However, claimed subject matter is not limited to any particular described embodiments, implementations, examples, etc.

For certain example embodiments, an operation 936 may be directed at least partially to wherein the comparing at least one analytical value to at least one analytical threshold (of operation 932) includes comparing the at least one analytical value to the at least one analytical threshold as part of an authorization-related decision. For certain example implementations, at least one device may compare at least one analytical value 728 (e.g., a numerical value, a code, a result of a calculation, a coefficient, a likelihood indication, a probabilistic output, a machine learning product, or a combination thereof, etc.) to at least one analytical threshold 730 (e.g., a level, a minimum or maximum, a point to measure against, an amount to use in a comparison, a defined range, or a combination thereof, etc.) as part of an authorization-related decision (e.g., a decision granting or denying permission, a signal indicating agreement or lack of agreement, a code providing or withholding approval, or a combination thereof, etc.). By way of example but not limitation, a server may compare the at least one analytical value to the at least one analytical threshold as part of an authorization-related decision (e.g., a Master Card server may compare (i) a probability that a current user of a Samsung Galaxy smartphone is an owner thereof with (ii) a minimum probabilistic authorization threshold as part of a decision as to whether a transaction requested via the Samsung Galaxy smartphone will be approved). However, claimed subject matter is not limited to any particular described embodiments, implementations, examples, etc.

FIG. 9D illustrates a flow diagram 900D having example operations 940, 942, 944, 946, or 948. For certain example embodiments, an operation 940 may be directed at least partially to wherein the performing at least one analysis for the event based at least partially on the at least one environmental parameter and at least partially on at least one utilization indicator of a behavioral fingerprint that is associated with the at least one user device (of operation 804) includes establishing at least one authentication likelihood based at least partially on the at least one environmental parameter and at least partially on the at least one utilization indicator of the behavioral fingerprint that is associated with the at least one user device. For certain example implementations, at least one device may establish at least one authentication likelihood 732 (e.g., a probability, a result of a calculation such as a maximum likelihood estimation, a numerical value, a coefficient, a machine learning product, a probability distribution, a Bayesian-derived output, or a combination thereof, etc. indicating at least one likelihood that a current or event-requesting user is at least likely who the user purports to be, is at least likely an authorized user of a user device, is at least likely to be a person that is currently signed into a user device, or a combination thereof, etc.) based at least partially on at least one environmental parameter 710 and at least partially on at least one utilization indicator 708 of a behavioral fingerprint 110 that is associated with at least one user device 102. By way of example but not limitation, a server may establish at least one authentication likelihood based at least partially on the at least one environmental parameter and at least partially on the at least one utilization indicator of the behavioral fingerprint that is associated with the at least one user device (e.g., a Google server may produce a probability distribution indicating how likely a current user of an HTC Android smartphone is to be an authorized user based at least partially on a security risk of a requested event and on an identification of people that have been contacted during the previous two hours using the HTC Android smartphone). However, claimed subject matter is not limited to any particular described embodiments, implementations, examples, etc.

For certain example embodiments, an operation 942 may be directed at least partially to wherein the establishing at least one authentication likelihood based at least partially on the at least one environmental parameter and at least partially on the at least one utilization indicator of the behavioral fingerprint that is associated with the at least one user device (of operation 940) includes increasing the at least one authentication likelihood based at least partially on the at least one environmental parameter and decreasing the at least one authentication likelihood based at least partially on the at least one utilization indicator of the behavioral fingerprint that is associated with the at least one user device. For certain example implementations, at least one device may increase the at least one authentication likelihood 732 (e.g., a probability, a result of a calculation such as a maximum likelihood estimation, a numerical value, a coefficient, a machine learning product, a probability distribution, a Bayesian-derived output, or a combination thereof, etc. indicating at least one likelihood that a current or event-requesting user is at least likely who the user purports to be, is at least likely an authorized user of a user device, is at least likely to be a person that is currently signed into a user device, or a combination thereof, etc.) based at least partially on at least one environmental parameter 710 and decrease authentication likelihood 732 based at least partially on at least one utilization indicator 708 of a behavioral fingerprint 110 that is associated with at least one user device 102. By way of example but not limitation, a server may increase the at least one authentication likelihood based at least partially on the at least one environmental parameter and decreasing the authentication likelihood based at least partially on the at least one utilization indicator of the behavioral fingerprint that is associated with the at least one user device (e.g., an Apple server may increase a probability variable representing a strength of expected user ‘authentic-ness’ if a requested purchase is for something that an iPhone has bought multiple times before but may decrease the probability variable as part of or after an analysis if the iPhone has been used to text more than one new destination since a previous affirmative authentication). However, claimed subject matter is not limited to any particular described embodiments, implementations, examples, etc.

For certain example embodiments, an operation 944 may be directed at least partially to wherein the establishing at least one authentication likelihood based at least partially on the at least one environmental parameter and at least partially on the at least one utilization indicator of the behavioral fingerprint that is associated with the at least one user device (of operation 940) includes weighing the at least one environmental parameter against the at least one utilization indicator of the behavioral fingerprint that is associated with the at least one user device. For certain example implementations, at least one device may weigh at least one environmental parameter 710 against at least one utilization indicator 708 of a behavioral fingerprint 110 that is associated with at least one user device 102. By way of example but not limitation, a server may weigh the at least one environmental parameter against the at least one utilization indicator of the behavioral fingerprint that is associated with the at least one user device (e.g., for a would-be purchase at a Macy's store using an Apple iPhone, a Capital One server may account for cumulative or contradictory indications from (i) an environmental parameter, such as whether a smartphone of another user that is included on a same Capital One account is present within the Macy's store, and (ii) a utilization indicator such as a route traveled to reach the Macy's store that is part of an existing behavioral fingerprint). However, claimed subject matter is not limited to any particular described embodiments, implementations, examples, etc.

For certain example embodiments, an operation 946 may be directed at least partially to wherein the establishing at least one authentication likelihood based at least partially on the at least one environmental parameter and at least partially on the at least one utilization indicator of the behavioral fingerprint that is associated with the at least one user device (of operation 940) includes adjusting the at least one authentication likelihood by comparing one or more environmental parameters to one or more corresponding utilization indicators of the behavioral fingerprint that is associated with the at least one user device. For certain example implementations, at least one device may adjust (e.g., change, increase, decrease, alter a distribution, or a combination thereof, etc.) at least one authentication likelihood 732 (e.g., a probability, a result of a calculation such as a maximum likelihood estimation, a numerical value, a coefficient, a machine learning product, a probability distribution, a Bayesian-derived output, or a combination thereof, etc. indicating at least one likelihood that a current or event-requesting user is at least likely who the user purports to be, is at least likely an authorized user of a user device, is at least likely to be a person that is currently signed into a user device, or a combination thereof, etc.) by comparing (e.g., determining if they match to a given degree, determining one or more similarities, determining one or more differences, or a combination thereof, etc.) one or more environmental parameters 710 to one or more corresponding (e.g., equivalent, analogous, comparable, similarly-categorized, or a combination thereof, etc.) utilization indicators 708 of a behavioral fingerprint 110 that is associated with at least one user device 102. By way of example but not limitation, a server may adjust the at least one authentication likelihood by comparing one or more environmental parameters to one or more corresponding utilization indicators of the behavioral fingerprint that is associated with the at least one user device (e.g., a Nokia server may adjust a Bayesian value responsive to a comparison of a location at which a Nokia Lumia phone receives user input requesting access to a Facebook account and one or more previous locations at which social networks have been accessed using the Nokia Lumia phone as indicated in a behavioral fingerprint). However, claimed subject matter is not limited to any particular described embodiments, implementations, examples, etc.

For certain example embodiments, an operation 948 may be directed at least partially to wherein the establishing at least one authentication likelihood based at least partially on the at least one environmental parameter and at least partially on the at least one utilization indicator of the behavioral fingerprint that is associated with the at least one user device (of operation 940) includes adjusting the at least one authentication likelihood based at least partly on one or more user acts that are detected in a period preceding the at least one analysis. For certain example implementations, at least one device may adjust (e.g., change, increase, decrease, alter a distribution, or a combination thereof, etc.) at least one authentication likelihood 732 (e.g., a probability, a result of a calculation such as a maximum likelihood estimation, a numerical value, a coefficient, a machine learning product, a probability distribution, a Bayesian-derived output, or a combination thereof, etc. indicating at least one likelihood that a current or event-requesting user is at least likely who the user purports to be, is at least likely an authorized user of a user device, is at least likely to be a person that is currently signed into a user device, or a combination thereof, etc.) based at least partly on one or more user acts (e.g., phone calls made or received, user interface manipulations, user device movements, social network interactions, apps employed, websites visited, or a combination thereof, etc.) that are detected (e.g., observed by a server, reported to a server, at least partially implemented by a server, or a combination thereof, etc.) in a period (e.g., one hour, a predetermined length of time, a time length that is variable based on a financial or security risk of an event, a user-selectable time length, or a combination thereof, etc.) preceding at least one analysis 712. By way of example but not limitation, a server may adjust the at least one authentication likelihood based at least partly on one or more user acts that are detected in a period preceding the at least one analysis (e.g., a McAfee server may increase a coefficient of authentication based on a number of detected acts, such as apps employed and social network members interacted with since a previous manual authentication, that match a set of predicted acts of a behavioral fingerprint). However, claimed subject matter is not limited to any particular described embodiments, implementations, examples, etc.

FIGS. 10A-10B depict example additions or alternatives for a flow diagram of FIG. 8A in accordance with certain example embodiments. As illustrated, flow diagrams of FIGS. 10A-10B may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently). Also, at least some operation(s) of flow diagrams of FIGS. 10A-10B may be performed so as to be fully or partially overlapping with other operation(s). For certain example embodiments, one or more operations of flow diagrams 1000A-1000B (of FIGS. 10A-10B) may be performed by at least one server device (e.g., a server device 112). Alternatively, one or more operations of flow diagrams 1000A-1000B may be performed by at least one user device (e.g., a user device 102).

FIGS. 10A-10B each illustrate a flow diagram 1000A-1000B, respectively, having an example operation 806. For certain example embodiments, an operation 806 may be directed at least partially to wherein a method further includes implementing one or more additional operations. For certain example implementations, at least one device may implement one or more operations in addition to obtaining (of operation 802) and performing (of operation 804). Example additional operations may include, by way of example but not limitation, 1010, 1012, 1014, 1016, 1018, 1022, 1024, or 1026 (of FIG. 10A or 10B).

FIG. 10A illustrates a flow diagram 1000A having example operations 1010, 1012, 1014, 1016, or 1018. For certain example embodiments, an operation 1010 may be directed at least partially to wherein a method of obtaining (of operation 802) and performing (of operation 804) further includes producing an authentication-related determination with regard to the at least one user device and with respect to the event based at least partially on the at least one analysis. For certain example implementations, at least one device may produce (e.g., make, create, acquire, provide, transmit, or a combination thereof, etc.) an authentication-related determination with regard to at least one user device 102 (e.g., a determination that a user is at least likely who the user purports to be, an ascertainment that a current user is at least likely an authorized user of a user device, a conclusion that a current user is at least likely to be a person that is currently signed into a user device, or a combination thereof, etc.) and with respect to an event 706 (e.g., on behalf of performing an event, when performance of an event is requested, for a benefit of event performance, or a combination thereof, etc.) based at least partially on at least one analysis 712. By way of example but not limitation, a server may produce an authentication-related determination with regard to the at least one user device and with respect to the event based at least partially on the at least one analysis (e.g., an Apple server may make a determination that a user of an iPhone corresponds to an active account of the iPhone with respect to utilization of a Pier One gift card stored on the iPhone with Apple's Passbook at a Pier One store based on an analysis of a style of products to be procured from the Pier One store along with a history of decor purchases as indicated with a behavioral fingerprint). However, claimed subject matter is not limited to any particular described embodiments, implementations, examples, etc.

For certain example embodiments, an operation 1012 may be directed at least partially to wherein the producing an authentication-related determination with regard to the at least one user device and with respect to the event based at least partially on the at least one analysis (of operation 1010) includes determining that a successful affirmative authentication is mandated for authentication with respect to occurrence of the event. For certain example implementations, at least one device may determine that a successful affirmative authentication (e.g., a correct entry of a password or PIN, offering a facial image that matches a stored facial image, providing a fingerprint that matches stored fingerprint characteristics, accurately answering one or more security questions, or a combination thereof, etc.) is mandated (e.g., is a precondition, is required, is instituted as a barrier to be surmounted, or a combination thereof, etc.) for authentication with respect to occurrence of an event 706 (e.g., prior to permitting the event to progress, before the event can be approved for completion, without which a requested task is barred, or a combination thereof, etc.). By way of example but not limitation, a server may determine that a successful affirmative authentication is mandated for authentication with respect to occurrence of the event (e.g., a Chase server may determine that a security code is to be entered by a user of a tablet computer to authenticate the user before the use is permitted to transfer funds from a Chase bank account to a new bank account). However, claimed subject matter is not limited to any particular described embodiments, implementations, examples, etc.

For certain example embodiments, an operation 1014 may be directed at least partially to wherein the producing an authentication-related determination with regard to the at least one user device and with respect to the event based at least partially on the at least one analysis (of operation 1010) includes determining that a current user of the at least one user device is an authorized user of the at least one user device. For certain example implementations, at least one device may determine that a current user (e.g., a user 104 that is directing operation of a user device at a time of a request for an event to occur, a user 104 that is manipulating user interface controls of a user device contemporaneously with a time of an analysis, a person that is holding a user device to activate something or perform an action, or a combination thereof, etc.) of at least one user device 102 is an authorized user (e.g., a user 104 that is authorized to use a given user device 102 to at least some extent, a user 104 that is associated with a behavioral fingerprint 110 corresponding to a given user device 102, an owner of a given user device 102, or a combination thereof, etc.) of at least one user device 102. By way of example but not limitation, a server may determine that a current user of the at least one user device is an authorized user of the at least one user device (e.g., a Google server may determine that a person attempting to access an email feature of an Android OS of a Nexus smartphone corresponds to a Google Account holder that initially setup the Nexus smartphone). However, claimed subject matter is not limited to any particular described embodiments, implementations, examples, etc.

For certain example embodiments, an operation 1016 may be directed at least partially to wherein the producing an authentication-related determination with regard to the at least one user device and with respect to the event based at least partially on the at least one analysis (of operation 1010) includes determining that a current user of the at least one user device matches an identity of a person that is currently signed into the at least one user device. For certain example implementations, at least one device may determine that a current user (e.g., a user 104 that is directing operation of a user device at a time of a request for an event to occur, a user 104 that is manipulating user interface controls of a user device contemporaneously with a time of an analysis, a person that is holding a user device to activate something or perform an action, or a combination thereof, etc.) of at least one user device 102 matches (e.g., corresponds to, is associated with a sufficiently reliable level of indicia of, is equivalent to, or a combination thereof, etc.) an identity of a person (e.g., a name of an individual, an account of a purchaser, a known behavioral fingerprint 110, or a combination thereof, etc.) that is currently signed into (e.g., that has previously affirmatively authenticated and not logged out since of, that is associated with a set of active device parameters or user preferences for, that belongs to an active profile of, or a combination thereof, etc.) at least one user device 102. By way of example but not limitation, a server may determine that a current user of the at least one user device matches an identity of a person that is currently signed into the at least one user device (e.g., a TrendMicro server may determine that a person manipulating a user interface of a Microsoft Surface tablet corresponds to a user account that is currently active on the tablet, such as because a person previously activated the user account by tracing a pattern on a picture). However, claimed subject matter is not limited to any particular described embodiments, implementations, examples, etc.

For certain example embodiments, an operation 1018 may be directed at least partially to wherein the producing an authentication-related determination with regard to the at least one user device and with respect to the event based at least partially on the at least one analysis (of operation 1010) includes determining that the event is likely to be performed by an authorized user of the at least one user device based at least partly on the behavioral fingerprint. For certain example implementations, at least one device may determine that an event 706 is likely to be performed (e.g., accomplished, carried out, completed, requested, continued, or a combination thereof, etc.) by an authorized user (e.g., a user 104 that is authorized to use a given user device 102 to at least some extent, a user 104 that is associated with a behavioral fingerprint 110 corresponding to a given user device 102, an owner of a given user device 102, or a combination thereof, etc.) of at least one user device 102 based at least partly on a behavioral fingerprint 110. By way of example but not limitation, a server may determine that the event is likely to be performed by an authorized user of the at least one user device based at least partly on the behavioral fingerprint (e.g., an Apple server may conclude that a request to post on Facebook from an iPad at an authorized user's house in the morning is likely to be performed by an authorized user based on indicator(s) from a behavioral fingerprint associated with the authorized user that indicate that Facebook is customarily interacted with between 9 am and noon each weekday). However, claimed subject matter is not limited to any particular described embodiments, implementations, examples, etc.

FIG. 10B illustrates a flow diagram 1000B having example operations 1022, 1024, or 1026. For certain example embodiments, an operation 1022 may be directed at least partially to wherein a method of obtaining (of operation 802) and performing (of operation 804) further includes making an authorization-related decision with regard to the at least one user device and with respect to the event based at least partially on a result of the at least one analysis. For certain example implementations, at least one device may make an authorization-related decision (e.g., a decision granting or denying permission, a signal indicating agreement or lack of agreement, a code providing or withholding approval, or a combination thereof, etc.) with regard to at least one user device 102 and with respect to an event 706 (e.g., on behalf of performing an event, when performance of an event is requested, for a benefit of event performance, or a combination thereof, etc.) based at least partially on a result (e.g., a conclusion, a positive answer, a negative answer, a likelihood value such as a probability, a predicted act, or a combination thereof, etc.) of at least one analysis 712. By way of example but not limitation, a server may make an authorization-related decision with regard to the at least one user device and with respect to the event based at least partially on a result of the at least one analysis (e.g., a Walmart server may decide that an order for delivery of groceries with regard to an HTC Windows Phone 8 is approved for delivery to a particular address if an analysis result indicates that the HTC Windows Phone 8 or an authenticated current user thereof has previously paid for delivery of groceries to the particular address). However, claimed subject matter is not limited to any particular described embodiments, implementations, examples, etc.

For certain example embodiments, an operation 1024 may be directed at least partially to wherein the making an authorization-related decision with regard to the at least one user device and with respect to the event based at least partially on a result of the at least one analysis (of operation 1022) includes deciding that the event may occur. For certain example implementations, at least one device may decide (e.g., conclude, determine, decree, or a combination thereof, etc.) that an event 706 may occur (e.g., happen, proceed, conclude, continue, or a combination thereof, etc.). By way of example but not limitation, a server may decide that the event may occur (e.g., an at&t server may decide that an attempt by a smartphone to deactivate GPS location or tracking of the smartphone may occur if a result of a behavioral fingerprint-involved analysis reveals that the smartphone is associated with a primary phone number of a wireless account). However, claimed subject matter is not limited to any particular described embodiments, implementations, examples, etc.

For certain example embodiments, an operation 1026 may be directed at least partially to wherein the making an authorization-related decision with regard to the at least one user device and with respect to the event based at least partially on a result of the at least one analysis (of operation 1022) includes deciding that a current user of the at least one user device is authorized to cause the event to occur with the at least one user device. For certain example implementations, at least one device may decide (e.g., conclude, determine, decree, or a combination thereof, etc.) that a current user (e.g., a user 104 that is directing operation of a user device at a time of a request for an event to occur, a user 104 that is manipulating user interface controls of a user device contemporaneously with a time of an analysis, a person that is holding a user device to activate something or perform an action, or a combination thereof, etc.) of at least one user device 102 is authorized (e.g., is invested with authority, is qualified, has permission, is empowered, or a combination thereof, etc.) to cause (e.g., order, start, initiate, compel, induce, or a combination thereof, etc.) an event 706 to occur with at least one user device 102. By way of example but not limitation, a server may decide that a current user of the at least one user device is authorized to cause the event to occur with the at least one user device (e.g., an Apple server may decide that an authenticated current user of an iPhone is an account holder of a corresponding credit card and is empowered to add money to an Apple account, such as iTunes, with the credit card using the iPhone). However, claimed subject matter is not limited to any particular described embodiments, implementations, examples, etc.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Modules, logic, circuitry, hardware and software combinations, firmware, or so forth may be realized or implemented as one or more general-purpose processors, one or more processing cores, one or more special-purpose processors, one or more microprocessors, at least one Application-Specific Integrated Circuit (ASIC), at least one Field Programmable Gate Array (FPGA), at least one digital signal processor (DSP), some combination thereof, or so forth that is executing or is configured to execute instructions, a special-purpose program, an application, software, code, some combination thereof, or so forth as at least one special-purpose computing apparatus or specific computing component. One or more modules, logic, or circuitry, etc. may, by way of example but not limitation, be implemented using one processor or multiple processors that are configured to execute instructions (e.g., sequentially, in parallel, at least partially overlapping in a time-multiplexed fashion, at least partially overlapping across multiple cores, or a combination thereof, etc.) to perform a method or realize a particular computing machine. For example, a first module may be embodied by a given processor executing a first set of instructions at or during a first time, and a second module may be embodied by the same given processor executing a second set of instructions at or during a second time. Moreover, the first and second times may be at least partially interleaved or overlapping, such as in a multi-threading, pipelined, or predictive processing environment. As an alternative example, a first module may be embodied by a first processor executing a first set of instructions, and a second module may be embodied by a second processor executing a second set of instructions. As another alternative example, a particular module may be embodied partially by a first processor executing at least a portion of a particular set of instructions and embodied partially by a second processor executing at least a portion of the particular set of instructions. Other combinations of instructions, a program, an application, software, or code, etc. in conjunction with at least one processor or other execution machinery may be utilized to realize one or more modules, logic, or circuitry, etc. to implement any of the processing algorithms described herein.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory). A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

This application may make reference to one or more trademarks, e.g., a word, letter, symbol, or device adopted by one manufacturer or merchant and used to identify and distinguish his or her product from those of others. Trademark names used herein are set forth in such language that makes clear their identity, that distinguishes them from common descriptive nouns, that have fixed and definite meanings, and, in many if not all cases, are accompanied by other specific identification using terms not covered by trademark. In addition, trademark names used herein have meanings that are well-known and defined in the literature, and do not refer to products or compounds protected by trade secrets in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or [trade], even when such trademark symbol does not explicitly appear next to the trademark. To the extent a trademark is used in a descriptive manner to refer to a product or process, that trademark should be interpreted to represent the corresponding product or process as of the date of the filing of this patent application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for environmentally-responsive behavioral fingerprinting, the method being at least partially implemented by at least one device, the method comprising:
obtaining at least one environmental parameter relating to an event to potentially occur in conjunction with at least one user device; and
performing at least one analysis for the event based at least partially on the at least one environmental parameter and at least partially on at least one utilization indicator of a behavioral fingerprint that is associated with the at least one user device.

2.-40. (canceled)

41. A system for environmentally-responsive behavioral fingerprinting, the system comprising:
circuitry for obtaining at least one environmental parameter relating to an event to potentially occur in conjunction with at least one user device; and
circuitry for performing at least one analysis for the event based at least partially on the at least one environmental parameter and at least partially on at least one utilization indicator of a behavioral fingerprint that is associated with the at least one user device.

42. The system of claim 41, wherein the circuitry for obtaining at least one environmental parameter relating to an event to potentially occur in conjunction with at least one user device comprises:
circuitry for obtaining at least one value of a transaction to potentially occur in conjunction with the at least one user device.

43. The system of claim 42, wherein the circuitry for obtaining at least one value of a transaction to potentially occur in conjunction with the at least one user device comprises:
circuitry for obtaining at least one cost of an item potentially being purchased in conjunction with the at least one user device.

44. The system of claim 41, wherein the circuitry for obtaining at least one environmental parameter relating to an event to potentially occur in conjunction with at least one user device comprises:
circuitry for obtaining at least one location relating to the event to potentially occur in conjunction with the at least one user device.

45. The system of claim 44, wherein the circuitry for obtaining at least one location relating to the event to potentially occur in conjunction with the at least one user device comprises:
circuitry for determining that the at least one location relating to the event to potentially occur in conjunction with the at least one user device corresponds to a home of an authorized user of the at least one user device.

46. The system of claim 41, wherein the circuitry for obtaining at least one environmental parameter relating to an event to potentially occur in conjunction with at least one user device comprises:
circuitry for obtaining at least one security risk parameter relating to the event to potentially occur in conjunction with the at least one user device.

47. The system of claim 46, wherein the circuitry for obtaining at least one security risk parameter relating to the event to potentially occur in conjunction with the at least one user device comprises:
circuitry for obtaining at least one parameter indicative of a security level relating to the event to potentially occur in conjunction with the at least one user device.

48. The system of claim 46, wherein the circuitry for obtaining at least one security risk parameter relating to the event to potentially occur in conjunction with the at least one user device comprises:
circuitry for obtaining at least one parameter indicative of funds that may be extended in relation to the event to potentially occur in conjunction with the at least one user device.

49. The system of claim 46, wherein the circuitry for obtaining at least one security risk parameter relating to the event to potentially occur in conjunction with the at least one user device comprises:
circuitry for obtaining at least one parameter indicative of whether personal confidential information may be exposed in relation to the event to potentially occur in conjunction with the at least one user device.

50. The system of claim 46, wherein the circuitry for obtaining at least one security risk parameter relating to the event to potentially occur in conjunction with the at least one user device comprises:
circuitry for obtaining at least one parameter indicative of whether communications may be accessible as a consequence of the event to potentially occur in conjunction with the at least one user device.

51. The system of claim 41, wherein the circuitry for obtaining at least one environmental parameter relating to an event to potentially occur in conjunction with at least one user device comprises:
circuitry for obtaining the at least one environmental parameter relating to the event, with the event requested by a current user of the at least one user device, to potentially occur in conjunction with the at least one user device.

52. The system of claim 41, wherein the circuitry for obtaining at least one environmental parameter relating to an event to potentially occur in conjunction with at least one user device comprises:
circuitry for obtaining the at least one environmental parameter relating to the event, with the event requested by at least a portion of the at least one user device, to potentially occur in conjunction with the at least one user device.

53. The system of claim 41, wherein the circuitry for obtaining at least one environmental parameter relating to an event to potentially occur in conjunction with at least one user device comprises:
circuitry for obtaining the at least one environmental parameter relating to the event to occur in conjunction with the at least one user device as conditioned on an authentication of a current user of the at least one user device.

54. The system of claim 41, wherein the circuitry for obtaining at least one environmental parameter relating to an event to potentially occur in conjunction with at least one user device comprises:
circuitry for obtaining the at least one environmental parameter relating to the event to occur in conjunction with the at least one user device as conditioned on an authorization for the event to be approved to unfold.

55. The system of claim 41, wherein the circuitry for obtaining at least one environmental parameter relating to an event to potentially occur in conjunction with at least one user device comprises:
circuitry for obtaining the at least one environmental parameter relating to the event to occur in conjunction with the at least one user device as conditioned on an absence of an attempt to block occurrence of the event.

56. The system of claim 41, wherein the circuitry for performing at least one analysis for the event based at least partially on the at least one environmental parameter and at least partially on at least one utilization indicator of a behavioral fingerprint that is associated with the at least one user device comprises:
circuitry for ascertaining at least one valuation for the event based at least partly on the at least one analysis.

57. The system of claim 56, wherein the circuitry for ascertaining at least one valuation for the event based at least partly on the at least one analysis comprises:
circuitry for assigning the at least one valuation to the event from multiple valuation levels based at least partly on the at least one analysis.

58. (canceled)

59. The system of claim 56, wherein the circuitry for ascertaining at least one valuation for the event based at least partly on the at least one analysis comprises:
circuitry for ascertaining at least one security valuation for the event based at least partly on the at least one analysis.

60. The system of claim 56, wherein the circuitry for ascertaining at least one valuation for the event based at least partly on the at least one analysis comprises:
circuitry for ascertaining at least one financial valuation for the event based at least partly on the at least one analysis.

61. The system of claim 41, wherein the circuitry for performing at least one analysis for the event based at least partially on the at least one environmental parameter and at least partially on at least one utilization indicator of a behavioral fingerprint that is associated with the at least one user device comprises:
circuitry for determining at least one analytical value based at least partially on the at least one environmental parameter and at least partially on the at least one utilization indicator of the behavioral fingerprint that is associated with the at least one user device.

62. The system of claim 61, wherein the circuitry for determining at least one analytical value based at least partially on the at least one environmental parameter and at least partially on the at least one utilization indicator of the behavioral fingerprint that is associated with the at least one user device comprises:
circuitry for increasing the at least one analytical value if a financial valuation is below a financial valuation threshold.

63. The system of claim 41, wherein the circuitry for performing at least one analysis for the event based at least partially on the at least one environmental parameter and at least partially on at least one utilization indicator of a behavioral fingerprint that is associated with the at least one user device comprises:
circuitry for determining at least one analytical threshold for the at least one analysis for the event responsive to the at least one environmental parameter or responsive to the at least one utilization indicator of the behavioral fingerprint that is associated with the at least one user device.

64. The system of claim 63, wherein the circuitry for determining at least one analytical threshold for the at least one analysis for the event responsive to the at least one environmental parameter or responsive to the at least one utilization indicator of the behavioral fingerprint that is associated with the at least one user device comprises:
circuitry for decreasing the at least one analytical threshold if a location of the at least one user device corresponds to a home location or a work location of at least one authorized user of the at least one user device.

65. The system of claim 41, wherein the circuitry for performing at least one analysis for the event based at least partially on the at least one environmental parameter and at least partially on at least one utilization indicator of a behavioral fingerprint that is associated with the at least one user device comprises:
circuitry for comparing at least one analytical value to at least one analytical threshold.

66. The system of claim 65, wherein the circuitry for comparing at least one analytical value to at least one analytical threshold comprises:
circuitry for comparing the at least one analytical value to the at least one analytical threshold as part of an authentication-related determination.

67. (canceled)

68. The system of claim 41, wherein the circuitry for performing at least one analysis for the event based at least partially on the at least one environmental parameter and at least partially on at least one utilization indicator of a behavioral fingerprint that is associated with the at least one user device comprises:
circuitry for establishing at least one authentication likelihood based at least partially on the at least one environmental parameter and at least partially on the at least one utilization indicator of the behavioral fingerprint that is associated with the at least one user device.

69. The system of claim 68, wherein the circuitry for establishing at least one authentication likelihood based at least partially on the at least one environmental parameter and at least partially on the at least one utilization indicator of the behavioral fingerprint that is associated with the at least one user device comprises:
circuitry for increasing the at least one authentication likelihood based at least partially on the at least one environmental parameter and decreasing the at least one authentication likelihood based at least partially on the at least one utilization indicator of the behavioral fingerprint that is associated with the at least one user device.

70. The system of claim 68, wherein the circuitry for establishing at least one authentication likelihood based at least partially on the at least one environmental parameter and at least partially on the at least one utilization indicator of the behavioral fingerprint that is associated with the at least one user device comprises:
circuitry for weighing the at least one environmental parameter against the at least one utilization indicator of the behavioral fingerprint that is associated with the at least one user device.

71. The system of claim 68, wherein the circuitry for establishing at least one authentication likelihood based at least partially on the at least one environmental parameter and at least partially on the at least one utilization indicator of the behavioral fingerprint that is associated with the at least one user device comprises:
circuitry for adjusting the at least one authentication likelihood by comparing one or more environmental parameters to one or more corresponding utilization indicators of the behavioral fingerprint that is associated with the at least one user device.

72. The system of claim 68, wherein the circuitry for establishing at least one authentication likelihood based at least partially on the at least one environmental parameter and at least partially on the at least one utilization indicator of the behavioral fingerprint that is associated with the at least one user device comprises:
circuitry for adjusting the at least one authentication likelihood based at least partly on one or more user acts that are detected in a period preceding the at least one analysis.

73. The system of claim 41, further comprising:
circuitry for producing an authentication-related determination with regard to the at least one user device and with respect to the event based at least partially on the at least one analysis.

74. The system of claim 73, wherein the circuitry for producing an authentication-related determination with regard to the at least one user device and with respect to the event based at least partially on the at least one analysis comprises:
circuitry for determining that a successful affirmative authentication is mandated for authentication with respect to occurrence of the event.

75. The system of claim 73, wherein the circuitry for producing an authentication-related determination with regard to the at least one user device and with respect to the event based at least partially on the at least one analysis comprises:
circuitry for determining that a current user of the at least one user device is an authorized user of the at least one user device.

76. The system of claim 73, wherein the circuitry for producing an authentication-related determination with regard to the at least one user device and with respect to the event based at least partially on the at least one analysis comprises:
circuitry for determining that a current user of the at least one user device matches an identity of a person that is currently signed into the at least one user device.

77. The system of claim 73, wherein the circuitry for producing an authentication-related determination with regard to the at least one user device and with respect to the event based at least partially on the at least one analysis comprises:
circuitry for determining that the event is likely to be performed by an authorized user of the at least one user device based at least partly on the behavioral fingerprint.

78. The system of claim 41, further comprising:
circuitry for making an authorization-related decision with regard to the at least one user device and with respect to the event based at least partially on a result of the at least one analysis.

79. (canceled)

80. (canceled)

81. A system for environmentally-responsive behavioral fingerprinting, the system comprising:
means for obtaining at least one environmental parameter relating to an event to potentially occur in conjunction with at least one user device; and
means for performing at least one analysis for the event based at least partially on the at least one environmental parameter and at least partially on at least one utilization indicator of a behavioral fingerprint that is associated with the at least one user device.

82.-120. (canceled)
